(19) United States
(12) Patent Application Publication
(10) Pub. No.: US 2018/0356565 A1
(43) Pub. Date: Dec. 13, 2018

(54) ANTISTATIC FILM, MANUFACTURING METHOD THEREFOR, POLARIZING PLATE AND LIQUID CRYSTAL DISPLAY DEVICE

(71) Applicant: ZEON CORPORATION, Chiyoda-ku, Tokyo (JP)

(72) Inventors: Manabu TSUBURAYA, Tokyo (JP); Mana SHIMODE, Tokyo (JP)

(73) Assignee: ZEON CORPORATION, Chiyoda-ku, Tokyo (JP)

(21) Appl. No.: 15/735,704

(22) PCT Filed: Jun. 24, 2016
(86) PCT No.: PCT/JP2016/068808

§ 371 Date: Dec. 12, 2017

(30) Foreign Application Priority Data
Jun. 26, 2015 (JP) 2015-129267

(51) Int. Cl. G02B 1/16; G02F 1/1335; G02B 5/30

(52) U.S. Cl. CPC G02B 1/16; G02F 2202/22; G02B 5/3025; G02F 1/133528

(57) ABSTRACT

An antistatic film including: a substrate film layer formed of a thermoplastic resin containing a polymer containing an alicyclic structure; and an antistatic layer containing metal oxide particles having electroconductivity, the antistatic layer being provided on the substrate film layer, wherein the antistatic layer has a surface resistance of 1.0×10⁶ Ω/square or more and 1.0×10¹⁰ Ω/square or less, and image clarity of a surface of the antistatic layer is 90 or more.

### FIELD

The present invention relates to an antistatic film and a method for producing the same, a polarizing plate, and a liquid crystal display device.

### BACKGROUND

An optical film containing a polymer containing an alicyclic structure has been conventionally used as a substrate film layer of a polarizing plate protective film for a liquid crystal display device, taking advantage of its excellent transparency and heat resistance (Patent Literature 1). It has been proposed to provide the polarizing plate protective film with an antistatic layer having electroconductivity, aiming at removal of static electricity from a liquid crystal display device (Patent Literature 2). Further, the polarizing plate protective film has sometimes been bonded to a masking film for suppressing decrease in transparency, contamination, and scratch during production, transport, and storage (Patent Literature 3).

### CITATION LIST

### Patent Literature

Patent Literature 1: Japanese Patent Application Laid-Open No. 2006-30870 A

Patent Literature 2: Japanese Patent Application Laid-Open No. 2014-112184 A

Patent Literature 3: Japanese Patent Application Laid-Open No. 2011-112945 A

### SUMMARY

### Technical Problem

In general, an optical film containing a polymer containing an alicyclic structure has low elastic modulus, and is soft. Therefore, when the optical film is bonded to a masking film and wound into a roll shape and the roll is stored for a certain period of time, a concavo-convex shape may be formed on a surface of the optical film. For example, when a masking film having a concavo-convex shape formed on a surface is used, the concavo-convex shape of the masking film may be transferred to the optical film due to a pressure at which the films are wound into a roll shape, to form a concavo-convex shape on the surface of the optical film.

When an antistatic layer is formed on the surface of such an optical film having a concavo-convex shape, a concavo-convex shape is likely to be formed also on the antistatic layer. Further, the concavo-convex shape formed on the antistatic layer tends to be emphasized. When a polarizing plate protective film including such an antistatic layer on which the concavo-convex shape is formed is provided in a liquid crystal display device, the outer appearance of the liquid crystal display device is evaluated as being poor, and the visibility may be deteriorated.

The present invention was made in view of the aforementioned problems. An object of the present invention is to provide an antistatic film capable of improving the visibility of an image, and a method for producing the same; a polarizing plate including the antistatic film capable of improving the visibility of an image; and a liquid crystal display device that includes the antistatic film and is capable of displaying an image with favorable visibility.

### Solution to Problem

The present inventor has intensively studied to solve the aforementioned problems. As a result, the inventor has found that when an antistatic film including a substrate film layer that is formed of a thermoplastic resin containing a polymer containing an alicyclic structure and an antistatic layer that contains metal oxide particles having electroconductivity, the antistatic layer having a surface resistance within a specific range and image clarity of a surface is provided in a liquid crystal display device, the visibility of an image can be improved. Thus, the present invention has been completed.

Specifically, the present invention is as follows.

(1) An antistatic film comprising: a substrate film layer formed of a thermoplastic resin containing a polymer containing an alicyclic structure; and an antistatic layer containing metal oxide particles having electroconductivity, the antistatic layer being provided on the substrate film layer, wherein

the antistatic layer has a surface resistance of 1.0×10⁶ Ω/square or more and 1.0×10¹⁰ Ω/square or less, and

image clarity of a surface of the antistatic layer is 90 or more.

(2) The antistatic film according to (1), comprising a masking film on a surface of the substrate film layer on a side opposite to the antistatic layer.

(3) The antistatic film according to (2), wherein

the masking film is in contact with a surface of the substrate film layer on a side of the substrate film layer, and

an arithmetic average roughness Ra and an average distance between concave and convex portions Sm of the surface of the masking film being in contact with the substrate film layer satisfy the following Expressions (i) and (ii):

Ra<0.08 μm Expression (i), and

Sm>0.6 mm Expression (ii).

(4) The antistatic film according to any one of (1) to (3), wherein

the substrate film layer includes a first surface layer, an intermediate layer, and a second surface layer in this order,

the intermediate layer contains an ultraviolet absorber, the substrate film layer has a thickness of 10 μm or more and 60 μm or less, and

a light transmittance of the substrate film layer at a wavelength of 380 nm is 10% or less.

(5) The antistatic film according to any one of (1) to (4), wherein the antistatic layer has a single-layer structure, and

a thickness of the antistatic layer is 0.8 μm to 10.0 μm.

(6) The antistatic film according to any one of (1) to (5), wherein a difference in refractive index between the antistatic layer and the substrate film layer is 0.03 or less.

(7) The antistatic film according to any one of (1) to (6), wherein the antistatic film has a haze value of 0.3% or less.

(8) The antistatic film according to any one of (1) to (7), wherein the antistatic film is a long-length film wound into a roll shape.

(9) The antistatic film according to (8), wherein

an in-plane retardation at a wavelength of 550 nm of the substrate film layer is 80 nm to 180 nm, and

an angle of a slow axis of the substrate film layer relative to a lengthwise direction of the substrate film layer is 45°±5°.

(10) A polarizing plate comprising the antistatic film according to any one of (1) to (9).

(11) A liquid crystal display device comprising a liquid crystal cell and the polarizing plate according to (10).

(12) The liquid crystal display device according to (11), wherein the liquid crystal cell is electrically connected to the antistatic layer of the antistatic film.

(13) The liquid crystal display device according to (11) or (12), wherein the liquid crystal display device is an IPS mode liquid crystal display device.

(14) A method for producing an antistatic film comprising the steps of:

bonding a masking film to a substrate film layer formed of a thermoplastic resin containing a polymer containing an alicyclic structure to obtain a multilayer film;

winding the multilayer film into a roll shape;

unwinding the roll-shaped wound multilayer film; and

forming an antistatic layer on the substrate film layer of the unwound multilayer film on a side opposite to the masking film, the antistatic layer containing metal oxide particles having electroconductivity, wherein

the antistatic layer has a surface resistance of 1.0×10⁶ Ω/square or more and 1.0×10¹⁰ Ω/square or less, and

image clarity of surface of the antistatic layer is 90 or more.

(15) The method for producing an antistatic film according to (14), wherein an arithmetic average roughness Ra and an average distance between concave and convex portions Sm of a surface of the masking film in contact with the substrate film layer satisfy the following Expressions (i) and (ii):

Ra<0.08 μm Expression (i), and

Sm>0.6 mm Expression (ii).

(16) The method for producing an antistatic film according to (14) or (15), wherein in the step of winding the multilayer film into a roll shape, a rubber roll is brought into contact with a surface of the multilayer film at a touch pressure of 0.05 MPa or more and 1.5 MPa or less and winding of the multilayer film is performed at a winding tension of 50 N/m or more and 250 N/m or less and such that the masking film is on the outside.

### Advantageous Effects of Invention

The present invention can provide an antistatic film capable of improving the visibility of an image, and a method for producing the antistatic film; a polarizing plate including the antistatic film capable of improving the visibility of an image; and a liquid crystal display device that includes the antistatic film and is capable of displaying an image with favorable visibility.

### BRIEF DESCRIPTION OF DRAWINGS

FIG. 1 is a cross-sectional view schematically illustrating an antistatic film according to an embodiment of the present invention.

FIG. 2 is a cross-sectional view schematically illustrating a polarizing plate according to an embodiment of the present invention.

FIG. 3 is a cross-sectional view schematically illustrating a liquid crystal display device according to an embodiment of the present invention.

### DESCRIPTION OF EMBODIMENTS

Hereinafter, the present invention will be described in detail by illustrating embodiments and examples. However, the present invention is not limited to the embodiments and examples described below. The present invention may be optionally modified without departing from the scope of claims of the present invention and its equivalent.

In the following description, a “long-length” film means a film having a length that is 5 or more times, and preferably 10 or more times the width, and specifically means a film having a length capable of being wound into a roll shape for storage or transport. The upper limit of the length of the long-length film is not particularly limited, and for example, may be 100,000 or less times the width.

Unless otherwise specified, an in-plane retardation Re of a film in the following description is a value represented by Re=(nx−ny)×d. Unless otherwise specified, a retardation Rth in the thickness direction of the film is a value represented by Rth={(nx+ny)/2−nz}×d. Herein, nx represents a refractive index in a direction among directions perpendicular to the thickness direction of the film (in-plane directions) that gives the largest refractive index. ny represents a refractive index in a direction among the in-plane directions that is orthogonal to the direction of nx. nz represents a refractive index in the thickness direction of the film. d represents a thickness of the film. Unless otherwise specified, a measurement wavelength is 550 nm.

In the following description, “(meth)acrylate” includes both “acrylate” and “methacrylate”, and “(meth)acryloyl group” includes both “acryloyl group” and “methacryloyl group”.

Unless otherwise specified, directions of elements that are “parallel”, “perpendicular”, and “orthogonal” in the following description may include an error within a range that does not impair the effects of the present invention, for example, within a range of ±5°.

In the following description, the lengthwise direction of the long-length film is usually parallel to the MD direction of the film in a production line.

In the following description, a “polarizing plate” and a “¼ wave plate” include not only a rigid member, but also a flexible member such as a film made of a resin unless otherwise specified.

In the following description, an angle formed between optical axes of a plurality of films in a member including the films (transmission axis of a polarizer, a slow axis of a phase difference film, etc.) represents an angle as viewed in the thickness direction of the films unless otherwise specified.

In the following description, a slow axis of the film represents a slow axis in the plane of the film unless otherwise specified.

In the following description, an adhesive includes not only a adhesive of a narrow sense but also a tacky agent of which the shear storage elastic modulus at 23° C. is less than 1 MPa. Herein, the adhesive in narrow sense represents an adhesive of which the shear storage elastic modulus at 23° C. after irradiation with an energy beam or after a heating treatment is 1 MPa to 500 MPa.

In the following description, a solid content of a liquid represents a component that remains after drying of the liquid.

[1. Summary of Antistatic Film]

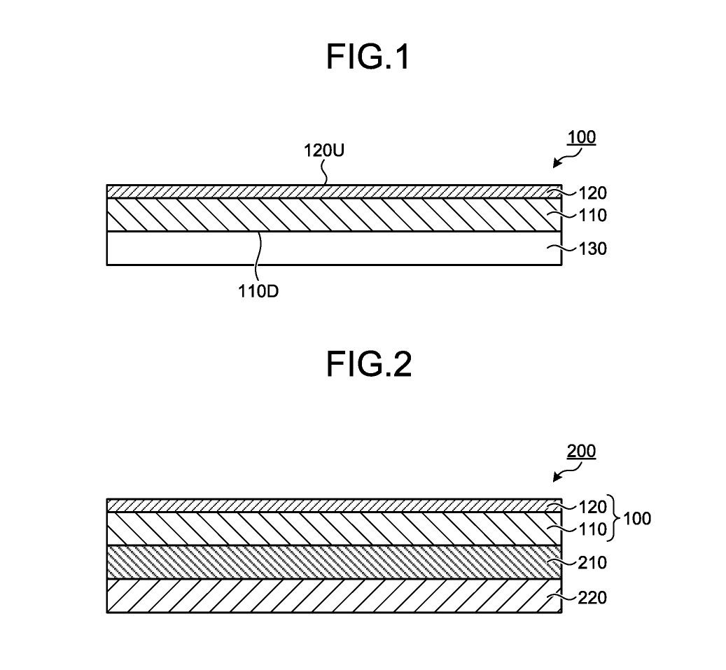

FIG. 1 is a cross-sectional view schematically illustrating an antistatic film 100 according to an embodiment of the present invention. As shown in FIG. 1, the antistatic film 100 includes a substrate film layer 110 and an antistatic layer 120 that is provided on the substrate film layer 110. The antistatic layer 120 has a surface resistance within a specific range. A surface 120U of the antistatic layer 120 on a side opposite to the substrate film layer 110 has an image clarity that is equal to or more than a specific value. When such an antistatic film 100 is provided in a liquid crystal display device, an action of preventing charging of electricity can be exerted and the visibility of an image can be improved.

The antistatic film 100 may include a masking film 130 on a surface 110D of the substrate film layer 110 on a side opposite to the antistatic layer 120, if necessary. The masking film 130 is provided to suppress contamination and scratch during transport and storage, and is usually separated during use of the antistatic film 100.

[2. Substrate Film Layer]

The substrate film layer is formed of a thermoplastic resin containing a polymer containing an alicyclic structure. Hereinafter, the polymer containing an alicyclic structure may be appropriately referred to as “alicyclic structure-containing polymer”. The alicyclic structure-containing polymer has an alicyclic structure as a structural unit of the polymer. The alicyclic structure-containing polymer may contain an alicyclic structure in a main chain, and may contain an alicyclic structure in a side chain. In particular, a polymer containing an alicyclic structure in a main chain is preferable from the viewpoint of mechanical strength and heat resistance.

Examples of the alicyclic structure may include a saturated alicyclic hydrocarbon (cycloalkane) structure and an unsaturated alicyclic hydrocarbon (cycloalkene or cycloalkyne) structure. Among these, a cycloalkane structure and a cycloalkene structure are preferable from the viewpoint of mechanical strength and heat resistance, and a cycloalkane structure is particularly preferable.

The number of carbon atoms constituting one alicyclic structure is preferably 4 or more and more preferably 5 or more, and is preferably 30 or less, more preferably 20 or less, and particularly preferably 15 or less. When the number of carbon atoms constituting one alicyclic structure falls within this range, mechanical strength, heat resistance, and moldability of the thermoplastic resin containing the alicyclic structure-containing polymer are highly balanced.

In the alicyclic structure-containing polymer, the ratio of a structural unit having the alicyclic structure may be appropriately selected depending on the purposes of use. The ratio of the structural unit having the alicyclic structure in the alicyclic structure-containing polymer is preferably 55% by weight or more, more preferably 70% by weight or more, and particularly preferably 90% by weight or more. When the range of the structural unit having the alicyclic structure in the alicyclic structure-containing polymer falls within this range, transparency and heat resistance of the thermoplastic resin containing the alicyclic structure-containing polymer are improved.

Examples of the alicyclic structure-containing polymer may include a norbornene-based polymer, a monocyclic olefin-based polymer, a cyclic conjugated diene-based polymer, and hydrogenated products thereof. Among these, a norbornene-based polymer is particularly suitable since it has favorable moldability. As the alicyclic structure-containing polymer, one type thereof may be solely used, and two or more types thereof may also be used in combination at any ratio.

As the norbornene-based polymer, for example, those described in Japanese Patent Application Laid-Open Nos. Hei. 3-14882 A, Hei. 3-122137 A, and Hei. 4-63807 A may be used. Specific examples of the norbornene-based polymer may include a ring-opening polymer of a monomer having a norbornene structure, and a hydrogenated product thereof; an addition polymer of a monomer having a norbornene structure, and a hydrogenated product thereof; and modified products thereof. In the following description, the monomer having a norbornene structure may be referred to as “norbornene-based monomer”. Examples of the ring-opening polymer of a norbornene-based monomer may include a ring-opening homopolymer of one type of monomer having a norbornene structure, a ring-opening copolymer of two or more types of monomers having a norbornene structure, and a ring-opening copolymer of a norbornene-based monomer with another monomer copolymerizable therewith. Examples of the addition polymer of a norbornene-based monomer may include an addition homopolymer of one type of monomer having a norbornene structure, an addition copolymer of two or more types of monomers having a norbornene structure, and an addition copolymer of a norbornene-based monomer with another monomer copolymerizable therewith. Among these, a hydrogenated product of the ring-opening polymer of a norbornene-based monomer is particularly suitable from the viewpoint of moldability, heat resistance, low hygroscopicity, size stability, and lightweight properties.

Examples of the norbornene-based monomer may include norbornene; an alkyl-substituted derivative of norbornene; an alkylidene-substituted derivative of norbornene; an aromatic substituted derivative of norbornene; and polar group-substituted products thereof. Herein, examples of the polar group may include halogen, a hydroxyl group, an ester group, an alkoxy group, a cyano group, an amido group, an imido group, and a silyl group. One type thereof may be solely used, and two or more types thereof may also be used in combination at any ratio. Specific examples of such a norbornene-based monomer may include 2-norbornene, 5-methyl-2-norbornene, 5,5-dimethyl-2-norbornene, 5-ethyl-2-norbornene, 5-butyl-2-norbornene, 5-ethylidene-2-norbornene, 5-methoxycarbonyl-2-norbornene, 5-cyano-2-norbornene, 5-methyl-5-methoxycarbonyl-2-norbornene, 5-phenyl-2-norbornene, 5-phenyl-5-methyl-2-norbornene, 5-hexyl-2-norbornene, 5-octyl-2-norbornene, and 5-octadecyl-2-norbornene.

Examples of the norbornene-based monomer may include a monomer in which one or more cyclopentadienes are added to norbornene; an alkyl-substituted derivative of the monomer; an alkylidene-substituted derivative of the monomer; an aromatic substituted derivative of the monomer; and polar group-substituted products thereof. Specific examples of such a norbornene-based monomer may include 1,4:5,8-dimethano-1,2,3,4,4a,5,8,8a-2,3-cyclopentadienooctahydronaphthalene, 6-methyl-1,4:5,8-dimethano-1,4,4a,5,6,7,8,8a-octahydronaphthalene, and 1,4:5,10:6,9-trimethano-1,2,3,4,4a,5,5a,6,9,9a,10,10a-dodecahydro-2,3-cyclopentadienoanthracene.

Further, examples of the norbornene-based monomer may include a monomer having a polycyclic structure that is a multimer of cyclopentadiene; an alkyl-substituted derivative of the monomer; an alkylidene-substituted derivative of the monomer; an aromatic substituted derivative of the monomer; and polar group-substituted products thereof. Specific examples of such a norbornene-based monomer may include dicyclopentadiene and 2,3-dihydrodicyclopentadiene.

Examples of the norbornene-based monomer may include an adduct of cyclopentadiene and tetrahydroindene; an alkyl-substituted derivative of the adduct; an alkylidene-substituted derivative of the adduct; an aromatic substituted derivative of the adduct; and polar group-substituted products thereof. Specific examples of such a norbornene-based monomer may include 1,4-methano-1,4,4a,4b,5,8,8a,9a-octahydrofluolene and 5,8-methano-1,2,3,4,4a,5,8,8a-octahydro-2,3-cyclopentadienonaphthalene.

As the norbornene-based monomer, one type thereof may be solely used, and two or more types thereof may also be used in combination at any ratio.

Of the norbornene-based polymers, a norbornene-based polymer having as structural units X: bicyclo[3.3.0]octane-2,4-diyl-ethylene structure and Y: tricyclo[4.3.0.1^{2,5}]decane-7,9-diyl-ethylene structure, wherein the content of the structural units is 90% by weight or more relative to the total of the structural units in the norbornene-based polymer, and the ratio by weight X:Y of the content ratio of X relative to the content ratio of Y is 100:0 to 40:60 is preferable. When such a polymer is used, a substrate film layer that is not changed in size over a long period of time and has excellent stability of optical properties can be obtained.

Examples of a monomer having the structure of X as a structural unit may include a norbornene-based monomer having a structure in which a five-membered ring is bonded to a norbornene ring. Specific examples thereof may include tricyclo[4.3.0.1^{2,5}]deca-3,7-diene (common name: dicyclopentadiene), and derivatives thereof (having a substituent in a ring), 7,8-benzotricyclo[4.3.0.1^{2,5}]dec-3-ene (common name: methanotetrahydrofluorene), and derivatives thereof. Examples of a monomer having the structure of Y as a structural unit may include tetracyclo[4.4.0.1^{2,5}.1^{7,10}]deca-3,7-diene (common name: tetracyclododecene) and derivatives thereof (having a substituent in a ring).

Polymerization of the monomer described above may be performed by a publicly known method. If necessary, the above-described monomer may be copolymerized with an optional monomer, or hydrogenated to obtain a desired polymer. When the monomer is hydrogenated, the hydrogenation ratio is 90% or more, preferably 95% or more, and more preferably 99% or more from the viewpoint of heat deterioration resistance and photo-deterioration resistance.

The obtained polymer may be modified, if necessary, with a modifier including α,β-unsaturated carboxylic acid and a derivative thereof, a styrene-based hydrocarbon, an organosilicon compound having an olefin-based unsaturated bond and a hydrolyzable group, and an unsaturated epoxy monomer.

The number-average molecular weight (Mn) of the alicyclic structure-containing polymer is preferably 10,000 or more, more preferably 15,000 or more, and is particularly preferably 20,000 or more, and preferably 200,000 or less, more preferably 100,000 or less, and particularly preferably 50,000 or less. When the number-average molecular weight falls within this range, mechanical strength and molding processability of the substrate film layer are highly balanced.

Herein, the number-average molecular weight of the alicyclic structure-containing polymer may be measured as a polyisoprene equivalent value by GPC (gel permeation chromatography) using cyclohexane as a solvent.

In the thermoplastic resin containing the alicyclic structure-containing polymer, the amount of the alicyclic structure-containing polymer is preferably 50% by weight to 100% by weight, and more preferably 70% by weight to 100% by weight. When the amount of the alicyclic structure-containing polymer falls within this range, a substrate film layer having desired properties can be easily obtained.

The thermoplastic resin containing the alicyclic structure-containing polymer may contain an optional component in combination with the alicyclic structure-containing polymer, if necessary. Examples of the optional component may include compounding agents including an ultraviolet absorber; inorganic fine particles; stabilizers such as an antioxidant, a thermal stabilizer, and a near-infrared absorber; resin modifying agent such as a lubricant and a plasticizer; colorants such as a dye and a pigment; and an aging resistor. As the optional component, one type thereof may be solely used, and two or more types thereof may also be used in combination at any ratio.

The substrate film layer may have a single-layer structure of only one layer. Alternatively, the substrate film layer may have a multilayer structure of two or more layers. In particular, it is preferable that the substrate film layer is a multilayer film including a first surface layer, an intermediate layer containing an ultraviolet absorber, and a second surface layer in this order in a thickness direction. That is, it is preferable that the substrate film layer includes a first surface layer formed of a thermoplastic resin containing an alicyclic structure-containing polymer, an intermediate layer formed of a thermoplastic resin containing an alicyclic structure-containing polymer and an ultraviolet absorber, and a second surface layer formed of a thermoplastic resin containing an alicyclic structure-containing polymer in this order in the thickness direction. In such a multilayer film, bleed-out of the ultraviolet absorber contained in the intermediate layer can be suppressed by the first surface layer and the second surface layer.

In order to effectively suppress the bleed-out, it is preferable that the first surface layer and the second surface layer do not contain the ultraviolet absorber. The polymer contained in the first surface layer, the polymer contained in the intermediate layer, and the polymer contained in the second surface layer may be the same or different. Therefore, the thermoplastic resin contained in the first surface layer and the thermoplastic resin contained in the second surface layer may be different from each other. However, it is preferable that these are the same since therewith the layers are easily formed. Usually, the first surface layer and the second surface layer are formed of a thermoplastic resin that is the same as the thermoplastic resin contained in the intermediate layer except that the ultraviolet absorber is not included.

Examples of the ultraviolet absorber may include organic ultraviolet absorbers such as a triazine-based ultraviolet absorber, a benzophenone-based ultraviolet absorber, a benzotriazole-based ultraviolet absorber, and an acrylonitrile-based ultraviolet absorber. Among these, a triazine-based ultraviolet absorber is preferable since it has excellent ultraviolet light absorption performance around a wavelength of 380 nm. It is preferable that the molecular weight of the ultraviolet absorber is 400 or more.

As the triazine-based ultraviolet absorber, for example, a compound having a 1,3,5-triazine ring may be preferably used. Specific examples of the triazine-based ultraviolet absorber may include 2-(4,6-diphenyl-1,3,5-triazin-2-yl)-5-[(hexyl)oxy]-phenol and 2,4-bis(2-hydroxy-4-butoxyphenyl)-6-(2,4-dibutoxyphenyl)-1,3,5-triazine. Examples of commercially available products of the triazine-based ultraviolet absorber may include “TINUVIN 1577” (available from Ciba Specialty Chemicals).

Examples of the benzotriazole-based ultraviolet absorber may include 2,2′-methylenebis[4-(1,1,3,3-tetramethylbutyl)-6-(2H-benzotriazol-2-yl)phenol], 2-(3,5-di-tert-butyl-2-hydroxyphenyl)-5-chlorobenzotriazole, 2-(2H-benzotriazol-2-yl)-p-cresol, 2-(2H-benzotriazol-2-yl)-4,6-bis(1-methyl-1-phenylethyl)phenol, 2-benzotriazol-2-yl-4,6-di-tert-butylphenol, 2-[5-chloro(2H)-benzotriazol-2-yl]-4-methyl-6-(tert-butyl)phenol, 2-(2H-benzotriazol-2-yl)-4,6-di-tert-butylphenol, 2-(2H-benzotriazol-2-yl)-4-(1,1,3,3-tetramethylbutyl)phenol, 2-(2H-benzotriazol-2-yl)-4-methyl-6-(3,4,5,6-tetrahydrophthalimidylmethyl)phenol, a reaction product of methyl 3-(3-(2H-benzotriazol-2-yl)-5-tert-butyl-4-hydroxyphenyl)propionate/polyethylene glycol 300, and 2-(2H-benzotriazol-2-yl)-6-(linear and side chain dodecyl)-4-methylphenol. Examples of commercially available products of the triazole-based ultraviolet absorber may include “ADK STAB LA-31” (available from Asahi Denka Co., Ltd.).

As the ultraviolet absorber, one type thereof may be solely used, and two or more types thereof may also be used in combination at any ratio.

In the thermoplastic resin contained in the intermediate layer, the amount of the ultraviolet absorber is preferably 1% by weight or more, and more preferably 3% by weight or more, and is preferably 8% by weight or less, and more preferably 6% by weight or less. Herein, when two or more types of ultraviolet absorbers are used, the amount of the ultraviolet absorber represents the total amount of the ultraviolet absorbers. When the amount of the ultraviolet absorber is equal to or more than the lower limit of the aforementioned range, transmission of ultraviolet light with a wavelength of 200 nm to 370 nm can be effectively suppressed. When it is equal to or less than the upper limit thereof, the yellowish tone of the film can be reduced. Therefore, deterioration of color tone can be suppressed. When the amount of the ultraviolet absorber falls within the aforementioned range, a large amount of ultraviolet absorber is not contained. Therefore, a decrease in heat resistance of the thermoplastic resin can be suppressed.

Examples of a method for producing the thermoplastic resin containing the alicyclic structure-containing polymer and the ultraviolet absorber may include a method in which the ultraviolet absorber is mixed in the alicyclic structure-containing polymer before the substrate film layer is produced by a melt extrusion method; a method of using a masterbatch containing the ultraviolet absorber in high concentration; and a method in which the ultraviolet absorber is mixed in the alicyclic structure-containing polymer when the substrate film layer is produced by a melt extrusion method. When the amount of the ultraviolet absorber falls within the aforementioned range in these methods, dispersibility of the ultraviolet absorber can be sufficiently enhanced.

The glass transition temperature of the thermoplastic resin is preferably 80° C. or higher, more preferably 100° C. or higher, further preferably 120° C. or higher, even more preferably 130° C. or higher, further more preferably 150° C. or higher, and particularly preferably 160° C. or higher, and is preferably 250° C. or lower, and more preferably 180° C. or lower. When the glass transition temperature of the thermoplastic resin is equal to or more than the lower limit value of the aforementioned range, durability of the substrate film layer in a high-temperature environment can be enhanced. When the glass transition temperature is equal to or less than the upper limit value thereof, a stretching treatment can be easily performed.

The photoelastic coefficient of the thermoplastic resin is preferably 10×10⁻¹⁰ Pa⁻¹ or less, more preferably 10×10⁻¹² Pa⁻¹ or less, and particularly preferably 4×10⁻¹² Pa⁻¹ or less. When the photoelastic coefficient of the thermoplastic resin falls within the aforementioned range, a change in retardation of the substrate film layer due to tensile stress during handling such as bonding can be suppressed. The photoelastic coefficient C is a value represented by C=Δn/σ when Δn is a birefringence and σ is a stress.

When the substrate film layer includes the first surface layer, the intermediate layer, and the second surface layer, it is preferable that the glass transition temperature TgA of the thermoplastic resin contained in the intermediate layer and the glass transition temperature TgB of the thermoplastic resin contained in the first surface layer and the second surface layer satisfy a relationship of TgB−TgA<15° C.

The light transmittance of the substrate film layer at a wavelength of 380 nm is preferably 10% or less, more preferably 5% or less, and particularly preferably 1% or less. The light transmittance of the substrate film layer at a wavelength of 280 nm to 370 nm is preferably 1.5% or less, and more preferably 1% or less. In this case, ultraviolet light can be blocked by the antistatic film. Therefore, in a liquid crystal display device provided with the antistatic film, a damage of a polarizer and a liquid crystal cell due to ultraviolet light can be suppressed. Accordingly, a decrease in degree of polarization and colorization of the polarizer can be suppressed. Further, liquid crystal driving of the liquid crystal cell can be stabilized.

Herein, the light transmittance may be measured by a spectrophotometer in accordance with JIS K 0115.

The substrate film layer may be an optically isotropic film. Alternatively, the substrate film layer may be an optically anisotropic film. For example, the substrate film layer may be an isotropic film having an in-plane retardation Re of 10 nm or less. When the substrate film layer is an isotropic film, the retardation Rth in the thickness direction of the substrate film layer is preferably 10 nm or less.

For example, the substrate film layer may be a phase difference film having optical anisotropy. Specifically, the substrate film layer may be a film that may function as a ¼ wave plate. When the substrate film layer may function as a ¼ wave plate, the in-plane retardation Re of the substrate film layer at a measurement wavelength of 550 nm is preferably 80 nm or more, and more preferably 95 nm or more, and is preferably 180 nm or less, and more preferably 150 nm or less. When the in-plane retardation Re of the substrate film layer falls within the aforementioned range and the antistatic film is incorporated into a liquid crystal display device, a change in color tone of an image observed through polarizing sunglasses decreases even the position of the device is changed about a display surface as a rotational axis. Therefore, visibility of the image on the liquid crystal display device is excellent. When the substrate film layer may function as a ¼ wave plate, the retardation Rth in the thickness direction of the substrate film layer at a measurement wavelength of 550 nm is preferably 50 nm to 225 nm.

When the substrate film layer is a long-length film that may function as a ¼ wave plate, it is preferable that the slow axis of the substrate film layer is set so that an angle of the slow axis relative to the lengthwise direction of the substrate film layer falls within a specific range. Herein, the angle of the slow axis of the substrate film layer relative to the lengthwise direction of the substrate film layer may be appropriately referred to as “orientation angle”. The range of the orientation angle is preferably 45°±5°, more preferably 45°±4°, and particularly preferably 45°±3°. When an antistatic film that includes the substrate film layer having an orientation angle within this range is used, a polarizing plate with which visibility of an image through polarizing sunglasses is enhanced can be easily produced.

The fluctuation of in-plane retardation Re of the substrate film layer is preferably within 10 nm, more preferably within 5 nm, and particularly preferably within 2 nm. The fluctuation of retardation Rth of the substrate film layer in the thickness direction is preferably within 20 nm, more preferably within 15 nm, and particularly preferably within 10 nm. When the fluctuations of retardations Re and Rth fall within the aforementioned ranges, display quality of a liquid crystal display device using the antistatic film can be made favorable.

The amount of volatile component in the substrate film layer is preferably 0.1% by weight or less, more preferably 0.05% by weight or less, and further preferably 0.02% by weight or less. When the amount of the volatile component is reduced, size stability can be improved, and change with the lapse of time of optical properties such as retardation can be reduced.

Herein, the volatile component is a substance having a molecular weight of 200 or less. Examples of the volatile component may include a residual monomer and a solvent. The amount of the volatile component may be quantified by analysis through gas chromatography as a total of substances having a molecular weight of 200 or less.

The thickness of the substrate film layer is preferably 10 μm or more, and more preferably 20 μm or more, and is preferably 60 μm or less, and more preferably 40 μm or less. When the thickness of the substrate film layer falls within this range, thickness of the antistatic film can be reduced. When the substrate film layer has the first surface layer, the intermediate layer, and the second surface layer, the thickness of the intermediate layer is preferably 5 μm or more and 30 μm or less, and the total thickness of the first surface layer and the second surface layer is preferably 5 μm or more and 20 μm or less. The ratio of the thickness of the intermediate layer relative to the sum of the thickness of the first surface layer and the second surface layer ((thickness of intermediate layer)/(total thickness of first surface layer and second surface layer)) is preferably 1 to 3 from the viewpoint of production stability. It is preferable that the fluctuation of thickness of the intermediate layer is within ±2.0 μm over its entire surface since image display properties of a liquid crystal display device can be improved.

The substrate film layer may be produced, for example, by molding the thermoplastic resin into a film shape. As the molding method, for example, a heating-melt molding method, a solution casting method, or the like may be used. In particular, the heating-melt molding method is preferably used since volatile component in the film can therewith be reduced. The heating-melt molding method may be specifically classified into a melt extrusion molding method, a press molding method, an inflation molding method, an injection molding method, a blow molding method, and a stretch molding method. Among these, the melt extrusion molding method is preferably used for obtaining a substrate film layer having excellent mechanical strength and surface precision.

For producing a multilayer film having two or more layers as the substrate film layer, a co-extrusion method is particularly preferably used. For example, a substrate film layer of multilayer structure having the first surface layer, the intermediate layer, and the second surface layer may be produced by co-extruding a thermoplastic resin for forming the first surface layer, a thermoplastic resin for forming the intermediate layer, and a thermoplastic resin for forming the second surface layer from a die. Of the co-extrusion method, a co-extrusion T-die method is preferable. Examples of the co-extrusion T-die method may include a feed block procedure and a multi-manifold procedure.

In the co-extrusion T-die method, the melting temperature of the thermoplastic resin in an extruder with a T-die is preferably Tg+80° C. or higher, and more preferably Tg+100° C. or higher, and is preferably Tg+180° C. or lower, and more preferably Tg+150° C. or lower. Herein, “Tg” represents the glass transition temperature of the thermoplastic resin. When the substrate film layer has the first surface layer, the intermediate layer, and the second surface layer, Tg represents the glass transition temperature of the thermoplastic resin contained in the first surface layer and the second surface layer. When the melting temperature in the extruder is equal to or higher than the lower limit value of the aforementioned range, flowability of the thermoplastic resin can be sufficiently enhanced. When the melting temperature is equal to or lower than the upper limit value thereof, deterioration of the thermoplastic resin can be suppressed.

In the melt extrusion molding method, the temperature of the thermoplastic resin at a resin charging port of the extruder is preferably Tg to (Tg+100)° C., the temperature of the thermoplastic resin at an outlet of the extruder is preferably (Tg+50) to (Tg+170)° C., and the temperature of the die is preferably (Tg+50)° C. to (Tg+170)° C.

The method for producing the substrate film layer may include a step of stretching the film obtained by the aforementioned molding method. By performing the stretching treatment, the substrate film layer can express optical properties such as retardation.

The stretching treatment may be performed by any method according to retardation to be expressed in the substrate film layer. For example, a uniaxial stretching treatment may be performed by stretching the film only in one direction, and a biaxial stretching treatment may be performed by stretching the film in two different directions. In the biaxial stretching treatment, a simultaneous biaxial stretching treatment may be performed by simultaneously stretching the film in two directions, and a sequential biaxial stretching treatment may be performed by stretching the film in one direction and then stretching the film in another direction. As the stretching treatment, a longitudinal stretching treatment may be performed by stretching the film in the lengthwise direction of the film, a transverse stretching treatment may be performed by stretching the film in the widthwise direction of the film, and a diagonal stretching treatment may be performed by stretching the film in a diagonal direction that is not parallel or perpendicular to the widthwise direction of the film. A combination of these stretching treatments may also be performed. Examples of procedure for the stretching treatment may include a roll procedure, a float procedure, and a tenter procedure.

Among the stretching treatments, the diagonal stretching treatment is preferable when the substrate film layer is a film that may function as a ¼ wave plate. When an antistatic film having the substrate film layer as a ¼ wave plate is bonded to a polarizer for use, usually bonding is performed so that the transmission axis of the polarizer and the slow axis of the substrate film layer are crossed at a specific angle, that is, are not parallel or perpendicular to each other. In general, a long-length polarizer has a transmission axis that is parallel or perpendicular to the lengthwise direction thereof. In this case, the substrate film layer obtained by the diagonal stretching treatment expresses the slow axis in a diagonal direction relative to the lengthwise direction of the substrate film layer. Therefore, it is not necessary to cut the antistatic film into a sheet piece shape for bonding, and it is thereby possible to achieve efficient bonding by a roll-to-roll process.

As the specific method for the diagonal stretching treatment, methods described in Japanese Patent Application Laid-Open No. Sho. 50-83482 A, Hei. 2-113920 A, Hei. 3-182701 A, 2000-9912 A, 2002-86554 A, 2002-22944 A, and the like may be employed. Examples of a stretching machine usable in the diagonal stretching treatment may include a tenter stretching machine. The tenter stretching machine includes a transversal uniaxial stretching machine, a simultaneous biaxial stretching machine, and the like. In particular, a tenter stretching machine capable of continuously stretching a long-length film in a diagonal direction is preferable.

The stretching temperature is preferably Tg−30° C. or higher, and more preferably Tg−10° C. or higher, and is preferably Tg+60° C. or lower, and more preferably Tg+50° C. or lower, on the basis of the glass transition temperature Tg of the thermoplastic resin contained in the substrate film layer.

The stretching ratio is preferably 1.01 times to 30 times, preferably 1.01 times to 10 times, and more preferably 1.01 times to 5 times.

If necessary, a surface treatment may be performed on the surface of the substrate film layer. For example, the surface of the substrate film layer on a side where the antistatic layer is provided may be subjected to a surface treatment such as a plasma treatment, a corona treatment, an alkali treatment, or a coating treatment, for enhancing the adhesion to the antistatic layer.

Of the surface treatments, the corona treatment is preferable. By the corona treatment, adhesion of the substrate film layer to the antistatic layer can be significantly enhanced. The irradiation dose of corona discharge electrons during the corona treatment is preferably 1 W/m²/min to 1,000 W/m²/min. The water contact angle of the surface of the substrate film layer that has been subjected to the corona treatment is preferably 10° to 50°. The water contact angle may be measured in accordance with JIS R3257 θ/2 method. For improving the outer appearance of the antistatic layer after the corona treatment, it is preferable to perform electricity removal treatment on the substrate film layer before the antistatic layer is formed on the surface having been subjected to the corona treatment.

[3. Antistatic Layer]

The antistatic layer is a layer provided on the substrate film layer, and contains metal oxide particles having electroconductivity. In this case, the antistatic layer may be provided indirectly on the substrate film layer through an optional layer. However, usually the antistatic layer is directly provided so as to be in contact with the surface of the substrate film layer. In the antistatic layer, the metal oxide particles are usually aggregated so as to be chain-linked, forming a chain-linked body. The chain-linked body forms an electroconductive path. Consequently, the antistatic film can exert an antistatic function.

[3.1. Metal Oxide Particles]

Examples of metal oxides contained in the metal oxide particles may include tin oxide; antimony, fluorine, or phosphorus-doped tin oxide; indium oxide; antimony, tin, or fluorine-doped indium oxide; antimony oxide; and low valent titanium oxide. In particular, antimony-doped tin oxide and antimony-doped indium oxide are preferable. One type thereof may be solely used, and two or more types thereof may also be used in combination at any ratio.

The average particle diameter of the metal oxide particles is preferably 2 nm or more, more preferably 4 nm or more, and particularly preferably 5 nm or more, and is preferably 50 nm or less, more preferably 40 nm or less, and particularly preferably 10 nm or less. When the average particle diameter of the metal oxide particles is equal to or more than the lower limit value of the aforementioned range, tendency to cause aggregation in a particle shape of the metal oxide particles can be reduced. Therefore, aggregation in a chain-linked manner of the metal oxide particles can be facilitated. When the average particle diameter is equal to or less than the upper limit value thereof, haze of the antistatic layer can be reduced. Therefore, the transparency of the antistatic layer can be enhanced. Further, connection in a chain-linked manner of the metal oxide particles to one another can be facilitated.

Herein, the average particle diameter of particles is a particle diameter in which the scattering strength is the highest when the particle diameter distribution measured by a laser diffraction method is assumed to show a normal distribution.

It is preferable that a surface of the metal oxide particles is treated with a hydrolyzable organosilicon compound. Of the metal oxide particles treated as described above, the surface of the body of the particles formed of the metal oxide is usually modified with the hydrolyzable organosilicon compound. Hereinafter, the treatment on the surface of the metal oxide particles with the hydrolyzable organosilicon compound is sometimes referred to as “modification treatment”. Further, the metal oxide particles of which the surface is treated with the hydrolyzable organosilicon compound is sometimes referred to as “modified particles”. By such a modification treatment, chain linkage between the metal oxide particles can be enhanced, and dispersibility of the metal oxide particles can be enhanced.

Examples of the hydrolyzable organosilicon compound may include organosilicon compounds represented by the following formula (1):

R¹ₐSi(OR²)₄₋ₐ (1)

(wherein R¹ and R² are each independently a group selected from the group consisting of a hydrogen atom, a halogen atom, a hydrocarbon group of 1 to 10 carbon atoms, and an organic group of 1 to 10 carbon atoms, and a is an integer of 0 to 3).

In the formula (1), preferable examples of R¹ may include a vinyl group, an acrylic group, and an alkyl group of 1 to 8 carbon atoms.

In the formula (1), preferable examples of R² may include a hydrogen atom, a vinyl group, an aryl group, an acrylic group, an alkyl group of 1 to 8 carbon atoms, and —CH₂OCₙH₂ₙ₊₁ (wherein n is an integer of 1 to 4).

The organosilicon compound represented by the formula (1) is preferably an organosilicon compound in which “a” is 0 or 1. A tetrafunctional organosilicon compound represented by the formula (1) wherein “a” is 0 is effective in maintaining the linkage between the metal oxide particles. A trifunctional organosilicon compound represented by the formula (1) wherein “a” is 1 is effective in enhancing the dispersibility of chain-linked metal oxide particles in an antistatic agent. As to an organosilicon compound represented by the formula (1) being trifunctional or having higher functionality wherein “a” is 0 or 1, such a compound usually shows a high hydrolysis rate.

As the organosilicon compound represented by the formula (1), it is preferable to use a combination of the tetrafunctional organosilicon compound in which “a” is 0 and the trifunctional organosilicon compound in which “a” is 1. When the organosilicon compounds are used in combination as described above, the molar ratio of the tetrafunctional organosilicon compound relative to the trifunctional organosilicon compound (tetrafunctional organosilicon compound/trifunctional organosilicon compound) is preferably 20/80 or more, and more preferably 30/70 or more, and is preferably 80/20 or less, and more preferably 70/30 or less. When the amount of the tetrafunctional organosilicon compound is not excessive, coagulation of the metal oxide particles into a lump can be suppressed, and generation of the chain linkage can thereby be facilitated. When the amount of the trifunctional organosilicon compound is not excessive, production of a gel during linking the metal oxide particles can be suppressed. Therefore, when the tetrafunctional organosilicon compound and the trifunctional organosilicon compound represented by the formula (1) are combined at the molar ratio described above, the metal oxide particles can be efficiently chain-linked.

When the tetrafunctional organosilicon compound and the trifunctional organosilicon compound represented by the formula (1) are used in combination as described above, the metal oxide particle can be tightly connected to one another in a chain-linked manner. This reason is not obvious, but it is assumed as follows. Since a linking moiety of the metal oxide particles has high activity, the tetrafunctional organosilicon compound in which “a” is 0 has a high tendency to adsorb on the linking moiety of the metal oxide particles. Since the tetrafunctional organosilicon compound has a high tendency to be hydrolyzed, hydrolysis is promoted simultaneously with mixing with alcohol, and a large amount of Si—OH is produced. The trifunctional organosilicon compound in which “a” is 1 has low degree of solubility in water. Therefore, when the trifunctional organosilicon compound is mixed with alcohol, the trifunctional organosilicon compound is dissolved in water, and hydrolysis is thereby promoted. Therefore, it is considered that the tetrafunctional organosilicon compound first absorbs on the linking moiety of the metal oxide particles and is subjected to hydrolysis, and the trifunctional organosilicon compound then reacts with Si—OH of the hydrolyzed tetrafunctional organosilicon compound.

Accordingly, when the tetrafunctional organosilicon compound and the trifunctional organosilicon compound are used in combination, it is not preferable to simultaneously mix these tetrafunctional organosilicon compound and trifunctional organosilicon compound with an aqueous dispersion of the metal oxide particles, but is preferable that the tetrafunctional organosilicon compound is first mixed with the aqueous dispersion of the metal oxide particles, and alcohol is then mixed, and at the same time, the trifunctional organosilicon compound is mixed.

Specific examples of the hydrolyzable organosilicon compound may include tetraalkoxysilanes such as tetramethoxysilane and tetraethoxysilane; trialkoxy or triacyloxysilanes such as methyltrimethoxysilane, methyltriethoxysilane, methyltriacetoxysilane, methyltripropoxysilane, ethyltrimethoxysilane, ethyltriethoxysilane, vinyltrimethoxysilane, vinyltriethoxysilane, vinyltriacetoxysilane, phenyltrimethoxysilane, phenyltrimethoxysilane, phenyltriethoxysilane, phenyltriacetoxysilane, γ-chloropropyltrimethoxysilane, γ-chloropropyltriethoxysilane, γ-chloropropyltripropoxysilane, γ-glycidoxypropyltrimethoxysilane, γ-glycidoxypropyltriethoxysilane, γ-(β-glycidoxyethoxy)propyltrimethoxysilane, γ-methacryloxypropyltrimethoxysilane, γ-aminopropyltrimethoxysilane, and γ-mercaptoproyltriethoxysilane; dialkoxysilanes or diacylsilanes such as dimethyldimethoxysilane, dimethyldiethoxysilane, phenylmethyldiethoxysilane, γ-glycidoxypropylmethyldimethoxysilane, γ-glycidoxypropylphenyldiethoxysilane, γ-chloropropylmethyldimethoxysilane, dimethyldiacetoxysilane, γ-methacryloxypropylmethyldimethoxysilane, γ-mercaptopropylmethyldimethoxysilane, and γ-aminopropylmethyldimethoxysilane; and trimethylchlorosilane. One type thereof may be solely used, and two or more types thereof may also be used in combination at any ratio.

Subsequently, a method for producing the modified particles (the metal oxide particles of which a surface is treated with the hydrolyzable organosilicon compound) will be described. In the method described below, the modified particles are produced in a state of dispersion.

In the method for producing the modified particles, the aqueous dispersion of the metal oxide particles as a subject to be treated is prepared. At that time, the concentration of the metal oxide particles in the aqueous dispersion is preferably 1% by weight or more, and more preferably 10% by weight or more, and is preferably 40% by weight or less.

Subsequently, the pH of the aqueous dispersion is adjusted preferably to 2 or more, more preferably to 2.5 or more, and preferably to 5 or less, and more preferably to 4 or less. When the pH of the aqueous dispersion is equal to or more than the lower limit value of this range, aggregation of the metal oxide particles into a spherical shape can be suppressed, and generation of the chain linkage can thereby be facilitated. When the pH is equal to or less than the upper limit value thereof, elevation of the number of linkages during formation of the chain linkage of the metal oxide particles can be facilitated. Therefore, the average number of linkages of the metal oxide particles can thereby be easily increased to as large as two or more. Accordingly, the antistatic performance of the antistatic film can thereby be easily enhanced.

Examples of the method for adjusting the pH may include an ion exchange treatment method using an ion exchange resin, and a method of mixing an acid. The ion exchange resin is preferably an H-type cation exchange resin. Usually, the pH of the aqueous dispersion can be shifted to acidity by an ion-exchange treatment. When the pH is not sufficiently decreased only by the ion exchange treatment using the ion exchange resin, an acid may be mixed in the aqueous dispersion, if necessary.

Usually, in the ion-exchange treatment, a deionization treatment is also performed. Therefore, the metal oxide particles tend to be oriented in a form of a chain.

It is preferable that, after the pH adjustment, the solid content concentration of the aqueous dispersion of the metal oxide particles is adjusted in an appropriate range by concentrating or diluting the aqueous dispersion. Specifically, the solid content concentration of the aqueous dispersion after the pH adjustment is adjusted preferably to 10% by weight or more, more preferably to 15% by weight or more, and preferably to 40% by weight or less, and more preferably to 35% by weight or less. When the solid content concentration of the aqueous dispersion of the metal oxide particles is equal to or more than the lower limit value of the aforementioned range, generation of the chain linkage of the metal oxide particles can be facilitated. Therefore, the average number of linkages of the metal oxide particles can thereby be easily increased to as large as three or more. Accordingly, the antistatic performance of the antistatic film can thereby be easily enhanced. When the average number is equal to or less than the upper limit value thereof, viscosity of the aqueous dispersion of the metal oxide particles can be reduced, and mixing by stirring can be sufficiently advanced. This allows uniform adsorption of the hydrolyzable organosilicon compound on the metal oxide particles.

After that, the aqueous dispersion of the metal oxide particles prepared as described above is mixed with the hydrolyzable organosilicon compound. Examples of the hydrolyzable organosilicon compound may include the compounds represented by the formula (1) described above.

The amount of the hydrolyzable organosilicon compound may be appropriately set according to elements such as the type of the organosilicon compound and the particle diameter of the metal oxide particles. The ratio by weight of the hydrolyzable organosilicon compound relative to the metal oxide particles (organosilicon compound/metal oxide particles) is preferably 0.01 or more, and more preferably 0.02 or more, and is preferably 0.5 or less, and more preferably 0.3 or less. When two or more types of organosilicon compounds are used, it is preferable that the total amount of the organosilicon compounds satisfies the aforementioned range of the ratio by weight. When the ratio by weight is equal to or more than the lower limit value of the aforementioned range, cleavage of linkage of the chain-linked metal oxide particles in the antistatic agent can be suppressed. Therefore, an antistatic film having excellent antistatic function can be obtained. Further, dispersibility of the metal oxide particles in the antistatic agent can be enhanced, viscosity of the antistatic agent can be reduced, and stability with the lapse of time of the antistatic agent can be improved. Accordingly, haze of the antistatic layer can be reduced. When the ratio by weight is equal to or less than the upper limit thereof, an excessive increase in thickness of a layer of hydrolysate of the organosilicon compound with which the surface of the metal oxide particles is modified can be suppressed. Therefore, the surface resistance of the antistatic layer can be reduced.

In the method for producing the modified particles described herein, a step of mixing the aqueous dispersion of the metal oxide particles with alcohol to hydrolyze the hydrolyzable organosilicon compound is performed. This step is usually performed after a step of mixing the aqueous dispersion of the metal oxide particles with the hydrolyzable organosilicon compound. When the tetrafunctional organosilicon compound and the trifunctional organosilicon compound are used in combination as described above, it is preferable that the tetrafunctional organosilicon compound is mixed with the aqueous dispersion of the metal oxide particles, and alcohol is then mixed in the aqueous dispersion. Further, it is preferable that the aqueous dispersion of the metal oxide particles is mixed with alcohol, and simultaneously or thereafter, the trifunctional organosilicon compound is mixed in the aqueous dispersion of the metal oxide particles.

Examples of the alcohol may include methyl alcohol, ethyl alcohol, normal propyl alcohol, isopropyl alcohol, and butanol. As the alcohol, one type thereof may be solely used, and two or more types thereof may also be used in combination at any ratio. In combination with the alcohol, an organic solvent such as ethylene glycol monomethyl ether, ethylene glycol monoethyl ether, ethylene glycol monobutyl ether, propylene glycol monomethyl ether, or propylene glycol monoethyl ether may be also used.

It is preferable that the amount of the alcohol is adjusted so that the solid content concentration of the aqueous dispersion of the metal oxide particles after mixing with the alcohol falls within a desired range. Herein, the desired range of the solid content concentration of the aqueous dispersion is preferably 3% by weight or more, and more preferably 5% by weight or more, and is preferably 30% by weight or less, and more preferably 25% by weight or less. The solid content concentration of the aqueous dispersion represents the concentration of a total solid content including the organosilicon compound. The amount of the organosilicon compound may be determined as an amount of silica equivalent.

The temperature during hydrolysis is preferably 30° C. or higher, and more preferably 40° C. or higher. The upper limit of the temperature during hydrolysis is usually equal to or lower than the boiling point of a solvent to be used (about 100° C.). When the temperature during hydrolysis is equal to or more than the lower limit value described above, a necessary period of time for hydrolysis can be shortened, and the amount of the hydrolyzable organosilicon compound remained can be reduced. When the temperature is equal to or less than the upper limit value described above, stability of the modified particles to be obtained can be improved, and excessive aggregation of the particles can thereby be suppressed.

If necessary, an acid may be mixed as a hydrolysis catalyst in the aqueous dispersion of the metal oxide particles. Examples of the acid may include hydrochloric acid, nitric acid, acetic acid, and phosphoric acid. As the acid, one type thereof may be solely used, and two or more types thereof may also be used in combination at any ratio.

Specifically, suitable examples of operation during hydrolysis of the organosilicon compound are as follows.

The tetrafunctional organosilicon compound represented by the formula (1) wherein “a” is 0 is first mixed with the aqueous dispersion of the metal oxide particles, and alcohol is mixed with the obtained aqueous dispersion, to hydrolyze the tetrafunctional organosilicon compound. After that, the aqueous dispersion is cooled to room temperature, and if necessary, the alcohol is mixed again. Subsequently, the trifunctional organosilicon compound represented by the formula (1) wherein “a” is 1 is mixed with the aforementioned aqueous dispersion, and the mixture is heated to the temperature suitable for the hydrolysis, to perform hydrolysis. With this operation, the chain linkage of the metal oxide particles can be maintained by the hydrolysate of the tetrafunctional organosilicon compound. Further, bonding of the hydrolysate of the trifunctional organosilicon compound to the surface of the metal oxide particles is promoted, and dispersibility of the metal oxide particles can thereby be enhanced.

When the organosilicon compounds are hydrolyzed as described above, the surface of the metal oxide particles are modified by the hydrolysates of the organosilicon compounds. Thus, the modified particles can be obtained. Immediately after hydrolysis, the modified particles may be obtained as a dispersion in which the modified particles are dispersed in a solvent such as water. The dispersion of the modified particles as it is may be used in preparation of the antistatic agent. However, the dispersion of the modified particles may be subjected to a cleaning treatment or a deionization treatment, if necessary. By the deionization treatment, the ion concentration is reduced. Thereby the dispersion of the modified particles that has excellent stability can be obtained. The deionization treatment may be performed using, for example, an ion exchange resin such as a cation exchange resin, an anion exchange resin, or an amphoteric ion exchange resin. The cleaning treatment may be performed by, for example, an ultrafiltration membrane method or the like.

The obtained dispersion of the modified particles may be used after solvent substitution, if necessary. By the solvent substitution, dispersibility in a binder polymer and a polar solvent is enhanced. Therefore, the applying properties of the antistatic agent can be improved. Accordingly, smoothness of the surface of the antistatic layer can be improved, and occurrence of defects of outer appearance, such as streaks and unevenness, of the antistatic layer can be suppressed. Further, scratch resistance, transparency, and adhesion of the antistatic layer can be improved, and haze can be reduced. In addition, production reliability of the antistatic film can be enhanced.

The obtained dispersion of the modified particles may be mixed with water and used, if necessary. When the dispersion is mixed with water, the number of linkages of the modified particles usually increases, and electroconductivity of the antistatic layer to be obtained is improved. Therefore, an antistatic layer with the surface resistance of about 10⁶ Ω/square to 10¹⁰ Ω/square can be obtained. Accordingly, an antistatic film having excellent antistatic properties can be obtained.

The metal oxide particles having electroconductivity described above (including the modified particles) are usually chain-linked in the dispersion containing the metal oxide particles or in the antistatic agent. The linkage described above is also maintained in the antistatic layer. Therefore, the electroconductive path is formed in the antistatic layer by the linked metal oxide particles. It is assumed that thereby the antistatic layer exerts excellent antistatic properties. Since the metal oxide particles are aggregated not in a particle shape but in a form of being chain-linked, the metal oxide particles are unlikely to be aggregated into such a large lump that may scatter visible light. It is assumed that thereby the haze of the antistatic layer containing such metal oxide particles can be reduced. However, the present invention is not limited to the aforementioned assumptions.

The average number of linkages of the metal oxide particles is preferably 2 or more, more preferably 3 or more, and particularly preferably 5 or more. When the average number of linkages of the metal oxide particles is equal to or more than the lower limit value, antistatic performance of the antistatic layer can be enhanced. The upper limit of the average number of linkages of the metal oxide particles is preferably 20 or less, and more preferably 10 or less. When the average number of linkages of the metal oxide particles is equal to or less than the upper limit value, the chain-linked metal oxide particles can be easily produced.

The average number of linkages of the metal oxide particles may be measured by the following method.

The chain-linked body of the metal oxide particles is photographed by a transmission electron microscope. From the photograph, the number of linkages in each of 100 chain-linked bodies of the metal oxide particles is determined. The average of the number of linkages in each chain-linked body is calculated, and the calculated value is rounded off to an integer, to obtain the average number of linkages of the metal oxide particles.

The amount of the metal oxide particles in the antistatic layer is preferably 3% by weight or more, more preferably 5% by weight or more, and particularly preferably 10% by weight or more, and is preferably 50% by weight or less, more preferably 30% by weight or less, and particularly preferably 20% by weight or less. When the amount of linkages of the metal oxide particles is equal to or more than the lower limit value of the aforementioned range, surface resistance of the antistatic layer can be reduced, to improve the antistatic performance. When the amount is equal to or less than the upper limit value thereof, haze of the antistatic layer can be reduced, and transparency of the antistatic film can thereby be enhanced.

[3.2. Binder Polymer]

The antistatic layer usually contains a binder polymer in addition to the metal oxide particles. By the binder polymer, the metal oxide particles can be held in the antistatic layer.

The binder polymer is preferably a polymer having a structure that is obtained by polymerizing a polymerizable monomer including 50% by weight or more of a compound having 3 or more (meth)acryloyl groups per one molecule. When such a polymer is used as the binder polymer, surface resistance of the antistatic layer can be effectively reduced.

Examples of the compound having 3 or more (meth)acryloyl groups per one molecule may include pentaerythritol tri(meth)acrylate, pentaerythritol tetra(meth)acrylate, dipentaerythritol tetra(meth)acrylate, dipentaerythritol penta(meth)acrylate, and dipentaerythritol hexa(meth)acrylate.

As the compound having 3 or more (meth)acryloyl groups per one molecule, one type thereof may be solely used, and two or more types thereof may also be used in combination at any ratio. For example, a combination of pentaerythritol tri(meth)acrylate with pentaerythritol tetra(meth)acrylate, or a combination of dipentaerythritol tetra(meth)acrylate, dipentaerythritol penta(meth)acrylate and dipentaerythritol hexa(meth)acrylate may be used as the polymerizable monomer for obtaining the binder polymer.

Of the aforementioned polymerizable monomers, a polymerizable monomer containing a compound having 4 (meth)acryloyl groups per one molecule, a compound having 5 (meth)acryloyl groups per one molecule and a compound having 6 (meth)acryloyl groups per one molecule in a total amount of 80% by weight or more is preferably used.

As the polymerizable monomer for obtaining the binder polymer, an optional monomer compound may be used in combination with the aforementioned compound having 3 or more (meth)acryloyl groups per one molecule. Examples of the optional monomer compound may include trifunctional (meth)acrylates such as trimethylolpropane tri(meth)acrylate and pentaerythritol tri(meth)acrylate; polyfunctional unsaturated monomers such as ethylene glycol diacrylate, ethylene glycol dimethacrylate, diethylene glycol dimethacrylate, allyl methacrylate, diallyl phthalate, trimethylolpropane triacrylate, glycerol diallyl ether, polyethylene glycol dimethacrylate, and polyethylene glycol diacrylate; compounds having an aromatic ring and a (meth)acryloyl group such as bisphenoxyethanolfluorene diacrylate, 2-propenoic acid [5,5′-(9-fluoren-9-ylidene)bis(1,1′-biphenyl)-2-(polyoxyethylene)ester], and 2-propenoic acid [5,5′-4-(1,1′biphenylyl)methylenebis(1,1′-biphenyl)-2-(polyoxyethylene)ester]; and acrylic unsaturated monomers of alkyl (meth)acrylates of 1 to 30 carbon atoms such as methyl (meth)acrylate, ethyl (meth)acrylate, butyl(meth)acrylate, hexyl (meth)acrylate, cyclohexyl (meth)acrylate, 2-ethylhexyl (meth)acrylate, octyl (meth)acrylate, nonyl (meth)acrylate, lauryl (meth)acrylate, and stearyl (meth)acrylate. One type thereof may be solely used, and two or more types thereof may also be used in combination at any ratio.

When a compound having a carboxyl group and a polymerizable carbon-carbon double bond is used as an optional monomer compound in an amount of 0.01% by weight to 5% by weight of the total amount of the polymerizable monomer, surface resistance of the antistatic layer can be effectively reduced. Examples of the compound having a carboxyl group and a polymerizable carbon-carbon double bond may include acrylic acid; methacrylic acid; crotonic acid; fumaric acid; itaconic acid; muconic acid; half esters of maleic anhydride and monoalcohol; compounds in which a part of hydroxyl group in acrylates having a hydroxyl group such as dipentaerythritol pentaacrylate and pentaerythritol triacrylate is added to a carbon-carbon double bond of an acrylic acid; and compounds obtained by reaction of a hydroxyl group in acrylates having a hydroxyl group such as dipentaerythritol pentaacrylate and pentaerythritol triacrylate with dicarboxylic acid or carboxylic acid anhydride. One type thereof may be solely used, and two or more types thereof may also be used in combination at any ratio.

The acid value of the polymerizable monomer containing 50% by weight or more of the compound having 3 or more (meth)acryloyl groups per one molecule is preferably 0.01 mgKOH/g to 0.5 mgKOH/g. When the acid value of the polymerizable monomer for obtaining the binder polymer is equal to or more than the lower limit value of the aforementioned range, surface resistance of the antistatic layer can be effectively reduced. When the acid value is equal to or less than the upper limit value thereof, stability of the antistatic agent can be improved.

The acid value of the polymerizable monomer may be measured using bromothymol blue as an indicator in accordance with JIS K 0070 (test methods for acid value, saponification value, ester value, iodine value, hydroxyl value, and unsaponifiable matter of chemical products).

The amount of the binder polymer in the antistatic layer is preferably 50% by weight or more, more preferably 60% by weight or more, and particularly preferably 70% by weight or more, and is preferably 95% by weight or less, and more preferably 90% by weight or less. When the amount of the binder polymer falls within the aforementioned range, adhesion of the antistatic layer and the substrate film layer can be reinforced, and dispersibility of the metal oxide particles in the antistatic layer can be enhanced. Further, thickness of the antistatic layer can be made uniform.

[3.3. Optional Components]

In addition to the metal oxide particles and the binder polymer, the antistatic layer may contain an optional component as long as the effects of the present invention are not significantly impaired. As the optional component, one type thereof may be solely used, and two or more types thereof may also be used in combination at any ratio.

[3.4. Method for Producing Antistatic Layer]

The antistatic layer may be formed by applying the antistatic agent containing the metal oxide particles onto the substrate film layer. The antistatic agent is usually a fluid during applying. Therefore, after the antistatic agent is applied onto the substrate film layer, it is preferable to perform a step of curing a film of the applied antistatic agent. Hereinafter, as one example of the method for producing the antistatic layer, a preferable production method in which the antistatic layer contains as a binder polymer a polymer obtained by polymerizing the polymerizable monomer containing 50% by weight or more of the compound having 3 or more (meth)acryloyl groups per one molecule will be described.

In the method for producing the antistatic layer shown in this example, the antistatic agent is first prepared. As the antistatic agent, an antistatic agent containing the metal oxide particles and the polymerizable monomer for obtaining the binder polymer is used in this example. As the polymerizable monomer, a polymerizable monomer containing 50% by weight or more of the compound having 3 or more (meth)acryloyl groups per one molecule is used.

The polymerizable monomer may be usually polymerized by irradiation with an active energy beam such as ultraviolet light. Therefore, it is preferable that the antistatic agent contains a photopolymerization initiator. Examples of the photopolymerization initiator may include benzoin derivatives, benzyl ketals, α-hydroxyacetophenones, α-aminoacetophenones, acylphosphine oxides, and o-acyl oximes. Examples of commercially available photopolymerization initiator may include combinations of benzophenone/amine, Michler's ketone/benzophenone, and thioxanthone/amine (trade name: IRGACURE, DAROCURE, and the like, available from Ciba-Geigy). As the photopolymerization initiator, one type thereof may be solely used, and two or more types thereof may also be used in combination at any ratio.

The amount of the photopolymerization initiator is preferably 1 part by weight or more, more preferably 2 parts by weight or more, and particularly preferably 3 parts by weight or more, and is preferably 20 parts by weight or less, more preferably 10 parts by weight or less, and particularly preferably 5 parts by weight or less, relative to 100 parts by weight of the polymerizable monomer. When the amount of the photopolymerization initiator falls within the aforementioned range, the polymerization of the polymerizable monomer can be efficiently advanced, excessive mixing of the photopolymerization initiator can be avoided, and yellowing of the antistatic layer and change in film properties due to an unreacted photopolymerization initiator can be suppressed.

The antistatic agent may contain a solvent. The solvent is preferably a solvent that is capable of dissolving the polymerizable monomer and can be easily volatilized. Examples of such a solvent may include water; alcohols such as methanol, ethanol, propanol, butanol, isopropanol, diacetone alcohol, furfuryl alcohol, tetrahydrofurfuryl alcohol, ethylene glycol, hexylene glycol, and isopropyl glycol; esters such as acetic acid methyl ester and acetic acid ethyl ester; ethers such as diethyl ether, ethylene glycol monomethyl ether, ethylene glycol monoethyl ether, ethylene glycol monobutyl ether, diethylene glycol monomethyl ether, diethylene glycol monoethyl ether, propylene glycol monomethyl ether, and tetrahydrofuran; ketones such as acetone, methyl ethyl ketone, methyl isobutyl ketone, acetylacetone, an acetoacetic acid ester, and cyclohexanone; cellosolves such as methyl cellosolve, ethyl cellosolve, and butyl cellosolve; aromatic compounds such as toluene and xylene; and isophorone. As the solvent, one type thereof may be solely used, and two or more types thereof may also be used in combination at any ratio.

Of the solvents, a hydrophilic solvent is preferable. When the hydrophilic solvent is used, moisture in the air is adsorbed in a step of drying the antistatic agent. That promotes formation of electroconductive path, and thus the antistatic performance can be enhanced. Specifically, a mixed solvent of ethanol, methanol, and 2-propanol (IPA, also referred to as isopropanol) is preferable.

Of the solvents, diacetone alcohol, cyclohexanone, and acetylacetone are preferable since they have a high boiling point, and use of which can improve flatness of the surface after drying of the film of the applied antistatic agent.

When the metal oxide particles are prepared in a state of dispersion containing water, it is preferable that a water-soluble solvent is used as the solvent of the antistatic agent.

It is preferable that the amount of the solvent is set so that the solid content concentration of the antistatic agent falls within a desired range. The solid content concentration of the antistatic agent is preferably 10% by weight or more, more preferably 20% by weight or more, and particularly preferably 30% by weight or more, and is preferably 70% by weight or less, and more preferably 55% by weight or less. When the solid content concentration of the antistatic agent falls within the aforementioned range, thickness of the antistatic layer can be easily confined to an appropriate range, and an antistatic layer having sufficient antistatic performance can be easily produced. Further, haze of the antistatic layer can thereby be usually reduced, and transparency of the antistatic film can be improved. Further, cracking of the antistatic layer and warping of the substrate film layer can thereby be usually suppressed. Further, viscosity of the antistatic agent can thereby be reduced, and applying properties of the antistatic agent can be improved. Accordingly, flatness of the surface of the antistatic layer can be improved, and generation of streak unevenness can be suppressed.

Further, the antistatic agent may contain an optional component that may be contained in the antistatic layer.

The antistatic agent may be obtained by mixing the components contained in the antistatic agent by an appropriate mixing apparatus. Examples of the mixing apparatus may include a homomixer.

After the antistatic agent is prepared, the antistatic agent is applied onto the substrate film layer, to form a film of the antistatic agent on the substrate film layer. If necessary, the solvent is removed from the film of the antistatic agent by drying. Subsequently, the film is irradiated with an active energy beam such as ultraviolet light to polymerize the polymerizable monomer. Thus, the film of the antistatic agent is cured to obtain the antistatic layer.

Examples of an applying method may include a bar-coating method, a slot coating method, a spin coating method, a roll coating method, a curtain coating method, a die coating method, and a screen printing method.

It is preferable that the application of the antistatic agent is performed in an environment of specific relative humidity. Specific relative humidity during applying described above is preferably 40% RH or more, more preferably 45% RH or more, further preferably 50% RH or more, and particularly preferably 52% RH or more, and is preferably 65% RH or less, more preferably 60% RH or less, further preferably 58% RH or less, and particularly preferably 57% RH or less. When the relative humidity in the environment during applying is equal to or more than the lower limit value of the aforementioned range, the metal oxide particles are aggregated and sufficiently chain-linked. Thus, the surface resistance of the antistatic layer can be effectively reduced. When the relative humidity in the environment during applying is equal to or more than the lower limit value of the aforementioned range, discharging due to electrical charging of the substrate film layer and applying unevenness due to electrical charging unevenness can be suppressed. When the relative humidity in the environment during applying is equal to or less than the upper limit value thereof, excessive aggregation of the metal oxide particles can be suppressed. Therefore, fracture of the antistatic layer and haze unevenness can be suppressed.

Herein, significance in which the relative humidity in the environment during applying is equal to or less than the upper limit value thereof will be specifically described.

In general, when a coating material containing a solvent is applied onto a substrate to form a coating film, the substrate is deprived of heat corresponding to vaporization heat of the solvent by volatilization of the solvent immediately after applying. As a result, dew condensation may occur on a surface of the coating film. This phenomenon is referred to as “brushing”. The appearance at a part where the brushing occurs may be whitened.

If the brushing occurs on the film of the antistatic agent formed on the substrate film layer as described above, aggregation of the metal oxide particles contained in the film of the antistatic agent may excessively proceed at the part where the brushing has occurred. When the aggregation of the metal oxide particles excessively proceeds, the antistatic layer may be fractured, and unevenness in haze of the antistatic layer may occur.

A part where the area of the film of the antistatic agent that is exposed to the air is large is likely to be affected by the brushing described above. This is because the large area exposed to the air brings about early onset of cooling, which in turn elevates tendency to cause the dew condensation.

In the vicinity of end parts of the film of the antistatic agent, not only the upper surface of the film of the antistatic agent but also the end surface of the antistatic layer is usually exposed to the air. Therefore, in the vicinity of end parts of the film of the antistatic agent, the larger area of the film of the antistatic agent is brought into contact with the air, to bring about early onset of cooling. Consequently, the film of the antistatic agent is likely to be cooled and dew condensation is likely to occur there. Accordingly, the vicinity of end parts of the film of the antistatic layer is affected by the brushing, and as a result, the antistatic layer is likely to be fractured and unevenness in haze is likely to occur.

When the relative humidity in the environment during applying is equal to or less than the upper limit value of the aforementioned range, occurrence of the brushing is suppressed. Therefore, in the overall layer including the vicinity of end parts of the antistatic layer, the fracture of the antistatic layer and unevenness in haze can be easily suppressed. Thus the confinement of the relative humidity in the environment during applying being equal to or less than the upper limit value of the aforementioned range has an significance in suppression of the aggregation of the electroconductive particles due to the brushing, and suppression of the fracture of the antistatic layer and unevenness in haze, whereby a uniform antistatic layer can be realized.

After the antistatic agent is applied onto the substrate film layer as described above, the solvent is removed from the film of the antistatic agent by drying, if necessary. The temperature and pressure during drying may be appropriately set according to conditions such as the type of material of the antistatic layer, the type of the solvent, and the thickness of the antistatic layer.

The film of the antistatic agent is irradiated with an active energy beam. As a result, the polymerizable monomer is polymerized to cure the film of the antistatic agent. Thus, the antistatic layer containing the metal oxide particles and the binder polymer is obtained. The irradiation conditions such as the wavelength and irradiation dose of the active energy beam may be appropriately set according to the conditions such as the type of material of the antistatic layer and the thickness of the antistatic layer.

[3.5. Structure and Size of Antistatic Layer]

The antistatic layer may have a multiple-layered structure including two or more layers, although it is preferable that the antistatic layer has a single-layer structure of only one layer. When the antistatic layer has a single-layer structure, total light transmittance of the antistatic layer can be increased, the antistatic layer can be easily produced, and thickness of the antistatic layer can be reduced.

The thickness of the antistatic layer is preferably 0.8 μm or more, more preferably 1.0 μm or more, and particularly preferably 1.5 μm or more, and is preferably 10.0 μm or less, more preferably 8 μm or less, further preferably 6 μm or less, and particularly preferably 4.0 μm or less. When the thickness of the antistatic layer falls within the aforementioned range, surface resistance of the antistatic layer can be suppressed within a specific range, and image visibility and stability of liquid crystal driving can be highly balanced. Further, curling of the antistatic film can be usually suppressed, and scratch resistance of the antistatic layer can be enhanced.

The thickness of the antistatic layer may be measured by an interference film thickness meter (“F20 film thickness measurement system” manufactured by Filmetrics, Inc.).

The ratio of the thickness of the antistatic layer relative to the thickness of the substrate film layer (antistatic layer/substrate film layer) is preferably 1/50 or more, more preferably 1/25 or more, and particularly preferably 1/12 or more, and is preferably 3/10 or less, more preferably ⅕ or less, and particularly preferably 3/25 or less. When the ratio of the thickness of the antistatic layer relative to the thickness of the substrate film layer falls within the aforementioned range, curling of the antistatic film can be stably suppressed.

[3.5. Properties of Antistatic Layer]

The surface resistance of the antistatic layer is usually 1.0×10⁶ Ω/square or more, preferably 1.0×10⁷ Ω/square or more, and more preferably 1.0×10⁸ Ω/square or more, and is usually 1.0×10¹⁰ Ω/square or less, preferably 5.0×10⁹ Ω/square or less, and more preferably 1.0×10⁹ Ω/square or less. When the antistatic layer has such a surface resistance, antistatic properties of the antistatic film can be enhanced. Therefore, when the antistatic film is incorporated into a liquid crystal display device having an in-cell type touch panel, occurrence of unevenness in liquid crystal driving due to electrical charging during operation of the touch panel can be suppressed. In particular, when the antistatic layer is electrically connected to a liquid crystal cell of the liquid crystal display device, electrical charging of the liquid crystal cell can be effectively suppressed, and stability of image display can be further enhanced.

The surface resistance may be measured by a digital ultra insulation megohmmeter/micro ammeter (“DSM-8104” manufactured by Hioki E.E. Corporation) in accordance with JIS K6911.

The image clarity (DOI: standards ASTM E430) of the surface of the antistatic layer is usually 90 or more, preferably 92 or more, and more preferably 94 or more, and is usually 100 or less. Herein, the surface of the antistatic layer specifically refers to a surface of the antistatic layer on a side opposite to the substrate film layer. When the surface of the antistatic layer has such image clarity, emphasis of the concavo-convex shape on the surface of the antistatic layer can be suppressed. Therefore, visibility of image on the liquid crystal display device having the antistatic film can be improved.

The image clarity may be measured in accordance with the standard of ASTM E430. Specifically, a sample is irradiated with LED light at an incidence angle of 60° by a measurement device such as Gardner WaveScan II (manufactured by BYK), and an intensity is detected at a reflection angle of 600. From the profile of the intensity, image clarity (DOI) may be calculated.

Examples of the method for keeping the image clarity of the surface of the antistatic layer within the aforementioned range may include a method of smoothening a surface of the substrate film layer on a side where the antistatic layer is formed; a method of smoothening a surface of plane of a substrate film on a side opposite to the antistatic layer; a method for smoothening a surface of a masking film on a side in contact with a substrate film; a method for smoothening a surface of a masking film on an opposite side of a plane in contact with a substrate film; and a method for smoothening the surface of the antistatic layer.

The refractive index of the antistatic layer is preferably 1.500 or more, more preferably 1.510 or more, further preferably 1.515 or more, and particularly preferably 1.520 or more, and is preferably 1.550 or less, and more preferably 1.540 or less.

It is preferable that the refractive index of the antistatic layer is set so that a difference in refractive index between the antistatic layer and the substrate film layer falls within a specific range. Specifically, the difference in refractive index is preferably 0.030 or less, more preferably 0.025 or less, and particularly preferably 0.020 or less, and ideally 0. When the difference in refractive index is reduced to the aforementioned value, reflection of light on an interface between the substrate film layer and the antistatic layer can be suppressed. Therefore, degree of visual recognition of unevenness of coating and uneven spots of the antistatic layer can be reduced. Therefore, the outer appearance of the antistatic film can be easily improved. Further, image clarity of surface of the antistatic layer can be enhanced. Accordingly, visibility of image on the liquid crystal display device provided with the antistatic film can be effectively enhanced.

Herein, the refractive indexes of the antistatic layer and the substrate film layer are values at a wavelength of 550 nm that are determined by performing Cauchy fitting on the basis of values measured at three wavelengths of 407 nm, 532 nm, and 633 nm by a refractive index and film thickness measurement device (“Prism Coupler” manufactured by Metricon Corporation). The difference in refractive index may be determined as an absolute value of the difference between the refractive index of the substrate film layer and the refractive index of the antistatic layer. Herein, when a refractive index of a layer has anisotropy, the average refractive index of the layer may be employed as the measured value of refractive index of the layer. For example, when the substrate film layer is a stretched film, the refractive index of the substrate film layer has anisotropy. In this case, the average value of a refractive index in a stretching direction (ns), a refractive index in an in-plane direction perpendicular to the stretching direction (nf), and a refractive index in a thickness direction (nz) may be employed as a measured value of the refractive index of the substrate film layer.

The water contact angle of the surface of the antistatic layer is preferably 70° to 90°. When the water contact angle of the surface of the antistatic layer falls within this range, cissing of an adhesive during adhesion of the antistatic film to an optional member through the adhesive can be suppressed. Consequently, when a gap between a polarizing plate having the antistatic film and a touch panel is filled with an interlayer adhesive during production of the liquid crystal display device, cissing between the interlayer adhesive and the polarizing plate can be suppressed. Therefore, workability during adhesion can be improved, and adhesion strength caused by the adhesive can be enhanced. Herein, the water contact angle may be measured in accordance with JIS R3257 θ/2 method.

The surface free energy of the antistatic layer is preferably 23 mJ/m² or more, and more preferably 24 mJ/m² or more, and is preferably 27 mJ/m² or less, and more preferably 26 mJ/m² or less. When the surface free energy of the antistatic layer falls within the aforementioned range, cissing of the adhesive during adhesion of the optional member to the antistatic film through the adhesive can be suppressed. Therefore, workability during adhesion can be improved, and the adhesion strength caused by the adhesive can be enhanced. Herein, the surface free energy of the antistatic layer may be calculated by Owens-Wendt analysis theory from data of the contact angle of hexadecane and the contact angle of water in the surface of the antistatic layer that are measured. “D. K. Owens, R. C. Wendt, J. Appl. Polym. Sci., 13, 1741, (1969)” may be referred to for the analysis theory.

The JIS pencil hardness of the antistatic layer is preferably B or more, more preferably HB or more, and particularly preferably H or more. When the antistatic layer has a high JIS pencil hardness, the antistatic layer may function as a hardcoat layer. Therefore, scratch resistance of the antistatic film can be enhanced. The JIS pencil hardness is determined by scratching the surface of the layer with pencils in accordance with JIS K5600-5-4. Scratching is performed with pencils with a variety of hardness which are inclined at the angle of 45° to which 500 gram force of downward load is applied. The hardness is determined as the hardness of the pencil that begins to create scratches.

The scratch resistance of the antistatic layer is determined as follows. The surface of the antistatic layer of the antistatic film is rubbed back and forth with steel wool #0000 ten cycles while a 10-gf, 50-gf, 100-gf, or 500-gf load is applied in 1-cm² square of the steel wool. After the rubbing, the surface state is visually observed, and a load under which a scratch is not recognized is determined.

The load under which a scratch is not recognized is preferably 10 gf or more, more preferably 50 gf or more, and particularly preferably 100 gf or more. When the scratch resistance of the antistatic layer is enhanced, scratching caused by unexpected external factor in a processing step such as formation into a polarizing plate can be suppressed.

From the viewpoint of utilizing high hardness of the antistatic layer described above, it is preferable that the antistatic layer is exposed on the outermost surface of the antistatic film.

[4. Masking Film]

The masking film is a film to be bonded to the substrate film layer for protection of the substrate film layer containing the alicyclic structure-containing polymer. Therefore, in the antistatic film, a surface of the masking film on a side of the substrate film layer is usually in contact with a surface of the substrate film layer on a side opposite to the antistatic layer. In the present invention, when a concavo-convex shape is formed on the surface of the masking film, the concavo-convex shape is likely to be transferred to a substrate film during bonding because of the use of the substrate film layer containing the alicyclic structure-containing polymer. Herein, the masking film has a surface in contact with the substrate film layer and a surface on a side opposite to the substrate film. The surface on the side opposite to the substrate film comes into contact with the substrate film layer through an air interface during winding into a roll shape. Therefore, the surface on the side opposite to the substrate film does not much affect the formation of the concavo-convex shape by transfer of the concavo-convex shape to the surface of the substrate film layer. On the other hand, the concavo-convex shape on the surface in direct contact with the substrate film layer largely affects the formation of the concavo-convex shape on the surface of the substrate film layer by transfer as compared with the concavo-convex shape on the surface of the masking film opposite to the substrate film layer. Therefore, it is preferable that the arithmetic average roughness Ra and the average distance Sm between the concave and convex portions of the surface of the masking film being in contact with the substrate film layer satisfy the following Expressions (i) and (ii).

Ra<0.08 μm Expression (i)

Sm>0.6 mm Expression (ii)

Specifically, the arithmetic average roughness Ra is preferably less than 0.08 μm, more preferably 0.045 μm or less, and particularly preferably 0.025 μm or less. The average distance Sm between the concave and convex portions is preferably more than 0.6 mm, more preferably 0.8 mm or more, and particularly preferably 0.9 mm or more, and is preferably 2.0 mm or less. The arithmetic average roughness Ra and the average distance Sm between the concave and convex portions may be measured by an interference roughness meter. As the measurement device, NewView series (manufactured by Zygo Corporation), Wyko series (manufactured by Nihon Veeco K.K.), VertScan series (manufactured by Ryoka Systems Inc.), or the like may be used.

When the Expressions (i) and (ii) are satisfied, it is possible to suppress formation of the concavo-convex shape on the surface of the substrate film layer that may occur after the substrate film layer containing the alicyclic structure-containing polymer and the masking film are bonded to each other, wound into a roll shape, and stored for a certain period of time. Therefore, when the antistatic layer is formed on the surface of the substrate film layer, image clarity of the surface of the antistatic layers can fall within the desired range described above. Accordingly, in the liquid crystal display device including the antistatic film including the antistatic layer, visibility of an image can be effectively enhanced. Herein, the storage period after the substrate film layer and the masking film are bonded to each other is not particularly limited, but is usually considered within a half year.

It is preferable that the masking film is a film including a supporting film layer and a tacky layer. When using such a masking film, the surface of the tacky layer on a side opposite to the supporting film layer is usually bonded to the substrate film layer.

Examples of the material for the supporting film layer of the masking film may include a polyethylene terephthalate film, a polyolefin, a polyester, acrylic, and triacetylcellulose. One type thereof may be solely used, and two or more types thereof may also be used in combination at any ratio. Among these, a polyester is preferable from the viewpoint of surface smoothness, heat resistance, and transparency. The polyester is not particularly limited, and for example, polyethylene terephthalate, polybutylene terephthalate, polytriethylene terephthalate, or the like may be suitably used.

The thickness of the supporting film layer of the masking film may vary depending on the thickness and required quality of the substrate film layer of the antistatic film, and is preferably 10 μm or more, and more preferably 15 μm or more, and is preferably 100 μm or less, and more preferably 50 μm or less. When the thickness of the supporting film layer is equal to or more than the lower limit value of the aforementioned range, occurrence of wrinkling due to the disordered outer appearance of roll of the masking film can be suppressed. When the thickness of the supporting film layer is equal to or less than the upper limit value thereof, peeling of the masking film from the substrate film layer can be suppressed, and the film can be easily wound.

Examples of the tacky layer of the masking film may include a tacky layer formed by coating and a self-tacky layer formed by co-extrusion. The tacky layer formed by coating is preferable since alternatives of the supporting film layer can be increased. In this case, examples of a tacky agent as a material for the tacky layer may include a rubber-based tacky agent, an acrylic tacky agent, a polyvinyl ether-based tacky agent, a urethane-based tacky agent, and a silicone-based tacky agent. As the tacky agent, one type thereof may be solely used, and two or more types thereof may also be used in combination at any ratio. Among these, the acrylic tacky agent is preferable from the viewpoint of heat resistance and productivity.

The thickness of the tacky layer of the masking film is preferably 2.0 μm or more, and more preferably 5.0 μm or more, and is preferably 20.0 μm or less, and more preferably 15.0 μm or less. When the thickness of the tacky layer is equal to or more than the lower limit value of the aforementioned range, tacky force of the tacky layer can be enhanced. Therefore, floating and peeling of the masking film can be suppressed. When the thickness of the tacky layer is equal to or less than the upper limit value thereof, glue residue after peeling of the masking film from the substrate film layer can be suppressed. Further, feeding tension of the masking film can be reduced. Therefore, occurrence of wrinkling and scratch during bonding of the substrate film layer to the masking film can be suppressed. Herein, “glue residue” represents a phenomenon in which, after peeling of the masking film, the tacky agent remains on the substrate film layer.

The number of defects of the masking film is preferably 5/m² or less, and more preferably 1/m² or less. Herein, the defects of the masking film refers to defects that can be visually confirmed, such as a fish eye of the supporting film layer, an embedded foreign substance, a fish eye of the tacky layer, and an attached foreign substance. When the number of defects falls within the aforementioned range, precise counting of the number of the foreign substance lumps of the antistatic layer can be easily performed during inspection of the foreign substance of the antistatic layer using a surface inspection device.

The haze of the masking film is preferably 6% or less, more preferably 4% or less, further preferably 3% or less, and particularly preferably 1% or less. In a case wherein the antistatic layer is formed on the substrate film layer with the masking film being bonded to the substrate film layer, the haze of the masking film falling within such a range enables evaluation of the antistatic layer without peeling of the masking film. Further, when the antistatic layer is subjected to the foreign substance inspection using a surface detection device, precise counting of the foreign substance of the antistatic layer can be easily performed.

When the substrate film layer is bonded to the masking film, the number of foreign substance having a longer diameter of 100 μm or more existing between the masking film and the substrate film layer is preferably 1/m² or less. Such a foreign substance may be caused by the concavo-convex structure of the substrate film layer, and what is called “lamination air voids” may be detected as the foreign substance.

In order to prevent contamination with the foreign substance and to suppress occurrence of wrinkling due to winding, a masking film having a configuration in which a separator is used in a tacky surface may be produced. In this case, in order to decrease a peeling force between the tacky surface and the separator and suppress electrical charging caused by peeling, the separator is generally subjected to a releasing treatment. As a release agent, a silicone-based release agent such as polydimethylsiloxane, a fluorine-based release agent such as alkyl fluoride, a long-chain alkyl-based release agent, or the like is used. Among these, the silicone-based release agent is suitably used since the releasing properties and processability are favorable. However, when the silicone-based release agent is attached to the substrate film layer, unevenness may occur in a subsequent step of forming the antistatic layer. Therefore, it is preferable that the amount of Si on the surface of the masking film is equal to or less than a specific amount. The Si amount on the surface of the masking film may be measured by X-ray photoelectron spectroscopy or X-ray fluorescence. In measurement by X-ray photoelectron spectroscopy, the Si amount on the surface of the masking film preferably 1.0 atm % or less. In measurement by X-ray fluorescence, the Si amount is preferably 0.3 kcps or less.

[5. Optional Layer]

The antistatic film may include an optional layer in combination with the substrate film layer, the antistatic layer, and the masking film.

For example, the antistatic film may have an antireflective layer provided on the antistatic layer.

The antistatic film may also have an adhesion facilitating layer provided on a surface of the substrate film layer on a side opposite to the antistatic layer.

[6. Properties and Shape of Antistatic Film]

The haze value of the antistatic film is preferably 0.3% or less, more preferably 0.2% or less, further preferably 0.1% or less, and particularly preferably 0.05% or less. When the antistatic film having a haze value within such a range, impairment of image visibility due to haze of a liquid crystal display device including this antistatic film can be suppressed, and the device can display a clear image.

The haze value of the antistatic film may be measured by a haze meter (“Haze Guard II” manufactured by Toyo Seiki Seisaku-sho, Ltd.) in accordance with JIS K7136.

The transmission hue L* of the antistatic film is preferably 94.0 or more, more preferably 94.5 or more, further preferably 94.7 or more, and particularly preferably 95.0 or more, and is preferably 97.0 or less, more preferably 96.5 or less, further preferably 96.3 or less, and particularly preferably 96.0 or less. When the transmission hue L* of the antistatic film falls within the aforementioned range, image visibility of the liquid crystal display device including the antistatic film can be improved.

The transmission hue L* is a coordinate L* in L*a*b* color coordinate system. The transmission hue L* of the antistatic film may be measured using a C-light source by a spectrophotometer (“V-7200” manufactured by JASCO Corporation).

The total light transmittance of the antistatic film is preferably 85% or more, more preferably 86% or more, and particularly preferably 88% or more.

The total light transmittance of the antistatic film may be measured within a wavelength range of 380 nm to 780 nm by an ultraviolet-visible spectrophotometer.

The antistatic film may be a long-length film. The antistatic film may also be a film in a sheet piece shape. From the viewpoint of enhancing the production efficiency, the antistatic film is usually produced as a long-length film, and wound into a roll shape for transportation and storage. When the antistatic film in a sheet piece form is produced, the long-length antistatic film is usually cut into a desired shape.

[7. Method for Producing Antistatic Film]

The antistatic film may be produced by a production method including a step of forming the antistatic layer on the substrate film layer. The antistatic film including the masking film may be produced by a production method including steps of forming the antistatic layer on the substrate film layer, and bonding the masking film to the substrate film layer. In this case, the step of bonding the masking film to the substrate film layer may be performed before or after the step of forming the antistatic layer on the substrate film layer. It is preferable that the method for producing an antistatic film is performed by a roll-to-roll process from the viewpoint of enhancing the production efficiency.

In particular, it is preferable that a long-length antistatic film including the masking film is produced by a production method including steps of: bonding the masking film to the substrate film layer to obtain a multilayer film; winding the multilayer film into a roll shape; unwinding the roll-shaped wound multilayer film; and forming the antistatic layer on the substrate film layer of the unwound multilayer film on a side opposite to the masking film. In this production method, the substrate film layer is stored as a layer contained in the multilayer film wound into a roll shape, and after storage, is unwound and subjected to the step of forming the antistatic layer. When the substrate film layer is wound into a roll shape and stored, the tendency to cause formation of a concavo-convex shape on the surface of the substrate film layer may be increased depending on the pressure between the wound multilayer film. It is preferable that the pressure between the wound multilayer film is controlled by adjusting the winding tension during winding the multilayer film. In this production method, it is preferable that the multilayer film is wound in a manner such that the masking film is on the outside of the multilayer film.

Specifically, the winding tension is preferably 50 N/m or more, more preferably 70 N/m or more, and particularly preferably 90 N/m or more, and is preferably 250 N/m or less, more preferably 200 N/m or less, and particularly preferably 180 N/m or less. When the winding tension of the multilayer film is equal to or more than the lower limit value of the aforementioned range, the multilayer film can be stably wound. When the winding tension is equal to or less than the upper limit value thereof, formation of the concavo-convex shape on the surface of the substrate film layer can be suppressed. As a result, image clarity of the antistatic layer can be easily adjusted within the specific range described above.

During winding, the multilayer film may be wound while a rubber roll is brought into contact with the surface of the multilayer film, if necessary. When a touch pressure at which the rubber roll is brought into contact with the surface of the multilayer film is adjusted, shifting of the multilayer film during winding can be suppressed. Specifically, the touch pressure is preferably 0.05 MPa or more, more preferably 0.07 MPa or more, and further preferably 0.10 MPa or more, and is preferably 1.5 MPa or less, more preferably 1.0 MPa or less, and further preferably 0.7 MPa or less. When the touch pressure of the multilayer film is equal to or more than the lower limit value of the aforementioned range, the multilayer film can be stably wound. When the touch pressure is equal to or less than the upper limit value thereof, formation of the concavo-convex shape on the surface of the substrate film layer can be suppressed. As a result, image clarity of the antistatic layer can be easily adjusted within the specific range described above.

The antistatic film produced by the aforementioned production method is usually wound into a roll shape for storage and transportation. Upon using, the antistatic film is unwound from the roll, and the masking film is peeled from the substrate film layer to expose the surface of the substrate film layer on a side opposite to the antistatic layer. Thus, the antistatic film is used by bonding the exposed surface to an optical member such as a polarizer.

[8. Polarizing Plate]

FIG. 2 is a cross-sectional view schematically illustrating a polarizing plate 200 according to an embodiment of the present invention. As shown in FIG. 2, the polarizing plate 200 may be obtained using the aforementioned antistatic film 100 as a polarizing plate protective film. In the polarizing plate 200, the aforementioned antistatic film 100 is used as the polarizing plate protective film. The polarizing plate 200 includes a polarizer 210 and the antistatic film 100. In this case, it is preferable that the antistatic layer 120 is exposed on the outermost surface of the polarizing plate 200 from the viewpoint of effectively using high hardness of the antistatic layer 120 and of facilitating grounding the antistatic layer 120 in the liquid crystal display device. In addition to the antistatic film 100, the polarizing plate 200 may include an optional polarizing plate protective film 220, if necessary. FIG. 2 shows the polarizing plate 200 including the optional polarizing plate protective film 220, the polarizer 210, the substrate film layer 110, and the antistatic layer 120 in this order as an example.

As the polarizer, any polarizer may be used. General polarizers may be those obtained by doping a polyvinyl alcohol-based film with iodine or the like, and then stretching the film.

The antistatic film is usually disposed in a direction whereby the substrate film layer is located closer to the polarizer than the antistatic layer. When the substrate film layer of the antistatic film may function as a ¼ wave plate, it is preferable that the slow axis of the substrate film layer of the antistatic film is disposed at a specific angle θ relative to the transmission axis of the polarizer. Specifically, the aforementioned angle θ is preferably 40° or more, and more preferably 43° or more, and is preferably 50° or less, more preferably 48° or less, and particularly preferably 45°±1°. In a liquid crystal display device including such a polarizer, linearly polarized light having passed through a liquid crystal cell and the polarizer can be converted into circularly polarized light or elliptically polarized light by the antistatic film. Therefore, an image can be displayed by circularly polarized light or elliptically polarized light. Consequently, a display content can be visually recognizable even when a user of the liquid crystal display device is in a state of wearing polarized sunglasses.

As the optional polarizing plate protective film, an optically isotropic film may be used, and a phase difference film having a desired retardation may also be used. When the phase difference film is used as the polarizing plate protective film, the phase difference film exerts an optical compensation function, to improve viewing angle dependence and compensate a light leakage phenomenon of the polarizer during oblique viewing, improving the viewing angle characteristics of the liquid crystal display device. As such a phase difference film, for example, a longitudinally uniaxially stretched film, a transversally uniaxially stretched film, a longitudinally and transversally biaxially stretched film, a phase difference film obtained by polymerization of a liquid crystal compound, or the like may be used. Specific examples of the phase difference film may also include films obtained by uniaxially or biaxially stretching a thermoplastic resin film formed of a thermoplastic resin such as a cycloolefin resin. Examples of the commercially available thermoplastic resin film may include “ZEONOR FILM” available from ZEON Corporation; “ESSINA” and “SCA40” available from Sekisui Chemical Co., Ltd.; and “ARTON Film” available from JSR Corporation.

The polarizer, the antistatic film, and the polarizing plate protective film may be integrated by bonding through an adhesive. The polarizer, the antistatic film, and the polarizing plate protective film may be directly bonded by a method such as a plasma treatment of surface of a member.

As the adhesive, any adhesive may be used. For example, a rubber-based, fluorine-based, acrylic, polyvinyl alcohol-based, polyurethane-based, silicone-based, polyester-based, polyamide-based, polyether-based, or epoxy-based adhesive may be used. As the adhesive, one type thereof may be solely used, and two or more types thereof may also be used in combination at any ratio. In particular, it is preferable that an ultraviolet light-curing adhesive layer such as an acrylic adhesive layer is provided between the polarizer and the antistatic film and the polarizer and the antistatic film are bonded through the ultraviolet light-curing adhesive layer. In this case, influence of moisture on the polarizer can be reduced. Therefore, deterioration of the polarizer can be suppressed. In this embodiment, the thickness of the adhesive layer is preferably 0.1 μm or more and 2.0 μm or less.

The polarizing plate may be produced by a production method including a step of bonding the polarizer to the antistatic film. From the viewpoint of efficient production, it is preferable that the polarizing plate is produced as a long-length polarizing plate from a long-length polarizer and a long-length antistatic film. The production method may be performed by a roll-to-roll process. Usually, when a liquid crystal display device is produced using such a polarizing plate, the long-length polarizing plate is cut into an appropriate size, and the cut polarizing plate is provided in the liquid crystal display device. As a method for cutting the polarizing plate in such a procedure, laser cutting, die cutting, cutting, or the like may be used.

[9. Liquid Crystal Display Device]

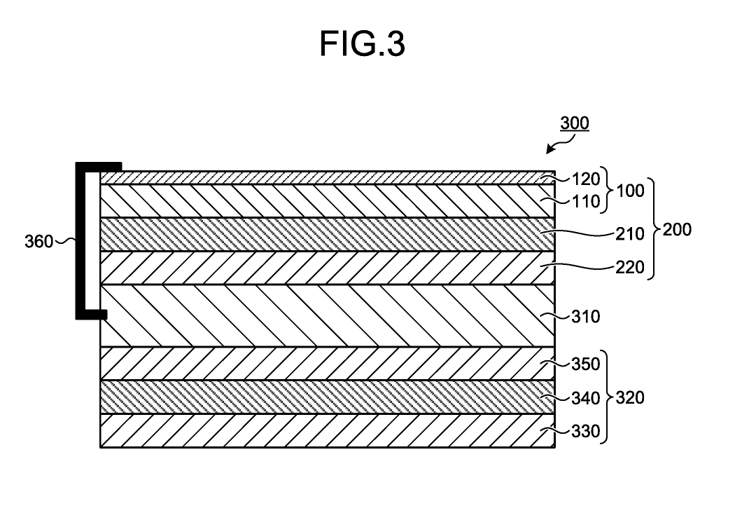

FIG. 3 is a cross-sectional view schematically illustrating a liquid crystal display device 300 according to an embodiment of the present invention. As shown in FIG. 3, the aforementioned antistatic film 100 may be provided in the liquid crystal display device 300 for use. Such a liquid crystal display device 300 includes a liquid crystal cell 310 and the polarizing plate 200 including the polarizer 210 and the antistatic film 100 described above. Usually, the polarizing plate 200 including the polarizer 210 and the antistatic film 100 is provided on a visual recognition side of the liquid crystal cell 310, and the antistatic film 100 is provided on a visual recognition side of the polarizer 210. FIG. 3 shows the liquid crystal display device 300 including an optional polarizing plate 320, the liquid crystal cell 310, the optional polarizing plate protective film 220, the polarizer 210, the substrate film layer 110, and the antistatic layer 120 in this order as one example. As the optional polarizer 320, an example in which the polarizing plate protective film 330, a polarizer 340, and a polarizing plate protective film 350 are provided in this order is shown.

Since the antistatic film has the antistatic layer and thereby has excellent antistatic properties, the control of liquid crystal molecule driving of the liquid crystal cell can be stabilized. Since the image clarity of surface of the antistatic layer falls within a specific range, visibility of the image can be improved. Since the substrate film layer of the antistatic film is formed of the thermoplastic resin containing the alicyclic structure-containing polymer, heat resistance and humidity resistance can be improved as compared with the conventional liquid crystal display devices including a polarizing plate protective film formed of a material such as triacetylcellulose.

Since the aforementioned antistatic film usually has excellent transparency, image clarity can be improved. Since an aqueous adhesive is unnecessary for bonding the antistatic film, a decrease in quality in an endurance test under high temperature and high humidity can be suppressed. When the substrate film layer of the antistatic film contains an ultraviolet absorber, constituent members such as the liquid crystal cell and the polarizer can be protected against irradiation of ultraviolet light in production of the liquid crystal display device and irradiation of ultraviolet light in outside light during use of the liquid crystal display device.

As the liquid crystal cell, any liquid crystal cell of, for example, TN mode, VA mode, or IPS mode may be used. Among these, an IPS mode liquid crystal cell is preferable because the display color of liquid crystal display does not change when the viewing angle is changed. It is preferable that the aforementioned antistatic film is provided in an IPS mode liquid crystal display device.

When the liquid crystal display device is used as a touch panel sensor, it is preferable that an in-cell type liquid crystal cell is used to reduce the thickness of the entire liquid crystal display device. The in-cell type liquid crystal cell tends to easily accumulate electrical charge. Therefore, the advantage of applying thereto the antistatic film described above can be particularly effectively taken.

In the liquid crystal display device, it is preferable that the liquid crystal cell is electrically connected to the antistatic layer of the antistatic film. Specifically, it is preferable that the liquid crystal cell is electrically connected to the antistatic layer of the antistatic film through an electrode (see a drawing electrode 360 in FIG. 3) to achieve conduction between the liquid crystal cell and the antistatic layer. By this structure, an electrical charge accumulated in the liquid crystal cell is discharged to the antistatic layer, to suppress electrical charging of the liquid crystal cell. Therefore, the driving control of liquid crystal molecules of the liquid crystal cell can be effectively stabilized.

Further, it is preferable that in the liquid crystal display device, the antistatic layer is grounded by electrical connection to an optional electroconductive member provided in the liquid crystal display device. By this structure, electrical charging of the liquid crystal cell can be effectively suppressed, and thereby the driving control of liquid crystal molecules of the liquid crystal cell can be effectively stabilized.

The antistatic layer is usually connected to the optional electroconductive member through a lead wire. The lead wire is usually fixed on the surface of the antistatic layer by a electroconductive adhesive material such as a silver paste, a carbon tape, and a metal tape. It is thus preferable for efficiently performing the grounding treatment that the grounding treatment for electrically connecting the antistatic layer to the optional electroconductive member is performed with the surface of the antistatic layer in a state of being exposed. The lead wire through which the antistatic layer is connected to the optional electroconductive member may be connected to the antistatic layer at one point on the surface of the antistatic layer, and may also be connected to the antistatic layer at a plurality of points on the surface of the antistatic layer.

It is preferable that a member provided outside a region in which an image can be visually recognized is used as the optional electroconductive member since the image display of the liquid crystal display device is not disturbed. Further, it is preferable that a member having small volume resistivity is used as the optional electroconductive member from the viewpoint of enhancing the electrical charging suppression effect. Specifically, the volume resistivity of the optional electroconductive member is preferably 1.0×10⁶ Ωm or less, more preferably 1.0×10³ Ωm or less, further preferably 1.0 Ωm or less, and particularly preferably 1.0×10⁻³ Ωm or less. Examples of a material for the optional electroconductive member may include silicon; carbon; metals such as iron, aluminum, copper, gold, and silver; alloys such as nichrome.

In the liquid crystal display device, members included in the liquid crystal display device such as the liquid crystal cell and the polarizing plate may be bonded through an adhesive, if necessary. Examples of the adhesive may include a urethane-based adhesive, an acrylic adhesive, a polyester-based adhesive, an epoxy-based adhesive, a vinyl acetate-based adhesive, a vinyl chloride-vinyl acetate copolymer, and a cellulose-based adhesive. The thickness of the adhesive layer is preferably 10 μm to 25 μm.

### EXAMPLES

Hereinafter, the present invention will be specifically described with reference to Examples. However, the present invention is not limited to the following Examples. The present invention may be optionally modified without departing from the scope of claims of the present invention and its equivalent. Unless otherwise specified, “%” and “part” that represent an amount in the following description are on the basis of weight. Unless otherwise specified, operations described below were performed under conditions of normal temperature and normal pressure.

[Evaluation Method]

### (Method for Measuring Average Number of Linkages of Metal Oxide Particles)

A chain-linked body of metal oxide particles was photographed by a transmission electron microscope. From the photograph, the number of linkages in each of 100 chain-linked bodies of the metal oxide particles was determined. The average thereof was calculated, and the calculated value was rounded off to an integer, to obtain the average number of linkages of the metal oxide particles.

(Method for Measuring Thickness of Substrate Film Layer)

The thickness of a substrate film layer was measured by a contact-type film thickness meter (“dial gauge” manufactured by Mitutoyo Corporation).

The thickness of each layer included in the substrate film layer was determined by embedding the substrate film layer in an epoxy resin, slicing the layer into a thickness of 0.05 μm with a microtome, and observing the cross section of the slice with a microscope.

(Method for Measuring Light Transmittance of Substrate Film Layer at Measurement Wavelength of 380 nm)

The light transmittance of the substrate film layer at a measurement wavelength of 380 nm was measured by a spectrophotometer (“V-650” manufactured by JASCO Corporation).

(Method for Measuring In-Plane Retardation Re and Orientation Angle of Substrate Film Layer)

The in-plane retardation Re and orientation angle of the substrate film layer at a wavelength of 550 nm were measured by Axoscan (“Axoscan” manufactured by Axiometrics).

(Method for Measuring Surface Roughness of Masking Film)

The arithmetic average roughness Ra and average distance Sm between concave and convex portions of a masking film were measured by measuring a surface of the masking film on a side for contacting with the substrate film layer (tacky surface side) in an MD direction by an interference surface roughness meter (“NewView7300” manufactured by Zygo Corporation). The measurement was performed under a condition of a magnification of objective lens of 1.0.

(Method for Measuring Si Amount on Surface of Masking Film)

The Si amount on a surface of the masking film was calculated on a basis of measurement of X-ray photoelectron spectroscopy.

(Method for Measuring Haze of Masking Film)

The haze value of the masking film was measured by a haze meter (“Haze Guard II” manufactured by Toyo Seiki Seisaku-sho, Ltd.) in accordance with JIS K7136. In measurement of the haze value, light was incident from a side of a supporting film layer.

(Method for Measuring Image Clarity of Antistatic Layer)

A surface of an antistatic layer on a side opposite to the substrate film layer was irradiated with LED light at an incidence angle of 60° by Gardner WaveScan II (manufactured by BYK), and the intensity was detected at a reflection angle of 600. From a profile of the intensity, the image clarity (DOI) was calculated. A measurement method was in accordance with a standard of ASTM E430.

(Method for Measuring Surface Resistance of Antistatic Layer)

An antistatic film was cut out to obtain a sample film having a square shape of 10 cm×10 cm. The surface resistance of a surface of the sample film on a side of the antistatic layer was measured by a digital ultra insulation megohmmeter/micro ammeter (“DSM-8104” manufactured by Hioki E.E. Corporation) in accordance with JIS K6911.

(Method for Measuring Thickness of Antistatic Layer)

The thickness of the antistatic layer was measured by an interference film thickness meter (“F20 film thickness measurement system” manufactured by Filmetrics, Inc.).

(Method for Measuring Haze Value of Antistatic Film)

The haze value of the antistatic film was measured by a haze meter (“Haze Guard II” manufactured by Toyo Seiki Seisaku-sho, Ltd.) in accordance with JIS K7136.

(Method for Measuring Difference in Refractive Index between Substrate Film Layer and Antistatic Layer)

The refractive indexes of the substrate film layer and the antistatic layer were measured at three wavelengths of 407 nm, 532 nm and 633 nm by a refractive index and film thickness measurement device (“Prism Coupler” manufactured by Metricon Corporation). When the substrate film layer was a stretched film, an average refractive index of the substrate film layer was calculated by an expression of (ns+nf+nz)/3 from a refractive index in a stretching direction (ns), a refractive index in an in-plane direction perpendicular to the stretching direction (nf), and a refractive index in the thickness direction (nz). The average refractive index was adopted as a measured value of refractive index of the substrate film layer. When the substrate film layer was an uniaxially stretched film, the refractive index in the thickness direction (nz) was approximated to be equal to the refractive index in the in-plane direction perpendicular to the stretching direction (nf), for calculation. The antistatic layer was not oriented and the refractive index was constant in any direction. Therefore, the refractive index in the lengthwise direction was adopted as the measured value of refractive index of the antistatic layer. On the basis of the measured values, the refractive index of each of the substrate film layer and the antistatic layer at a wavelength of 550 nm was calculated by performing Cauchy fitting. The absolute value of difference between the calculated refractive indexes was calculated as the difference in refractive index.

(Method for Evaluating Image Visibility of Liquid Crystal Display Device)

An image was displayed on a display surface of a liquid crystal display device. The display surface in this state was observed from the front direction through polarized sunglasses. The observation was performed in eight setting directions with the display surface being rotated at 45° intervals about a central rotational axis perpendicular to the display surface.

At that time, when the color tone of the image was not changed in all of the directions and the image was clearly visually recognized, the image visibility was determined to be very favorable, which was rated “3”.

When the image visibility was slightly deteriorated by slight blurring of the image or slight color tone change of the image depending on the setting directions although there was not a problem for practical use, the image visibility was determined to be favorable, which was rated “2”.

When there was a significant blurring of the image, a significant color tone change depending on the setting directions, or a significant display unevenness, the image visibility was determined to be poor, which was rated “1”.

(Method for Evaluating Stability of Liquid Crystal Driving of Liquid Crystal Display Device)

A touch panel of a liquid crystal display device was operated. At that time, when the image was visually recognized without occurrence of disordered liquid crystal driving, the stability of liquid crystal driving was determined to be very favorable, which was rated “3”. When disordered liquid crystal driving infrequently occurred, the stability of liquid crystal driving was determined to be favorable, which was rated “2”. When the image was disordered and the display unevenness was recognized, the stability of liquid crystal driving was determined to be poor, which was rated “1”.

### Production Example 1: Production of Metal Oxide Particles

130 g of potassium stannate and 30 g of potassium antimonyl tartrate were dissolved in 400 g of pure water to prepare a mixed solution.

1.0 g of ammonium nitrate and 12 g of 15% ammonia water were dissolved in 1,000 g of pure water to prepare an aqueous solution. While this aqueous solution was stirred at 60° C., the mixed solution was added to this aqueous solution over 12 hours for effecting hydrolysis. During this operation, a 10% nitric acid solution was simultaneously added to the aforementioned aqueous solution so that the pH of the aqueous solution was kept to 9.0. By the hydrolysis, a precipitate was produced in the aqueous solution.

The produced precipitate was filtered off, washed, and then dispersed in water again, to prepare a dispersion liquid of a hydroxide of a Sb-doped tin oxide precursor of which the solid content concentration was 20% by weight. This dispersion liquid was spray-dried at a temperature of 100° C., to obtain powders. The obtained powders were heated at 550° C. for 2 hours under an air atmosphere, to obtain powders of antimony-doped tin oxide.

60 Parts of the powders were dispersed in 140 parts of an aqueous solution of 4.3% by weight potassium hydroxide, to obtain an aqueous dispersion liquid. While this aqueous dispersion liquid was held to 30° C., the powders were crushed by a sand mill for 3 hours, to prepare a sol. Subsequently, the sol was subjected to a dealkalization ion treatment using an ion exchange resin until the pH reached 3.0. To this sol, pure water was then added, to prepare a particle dispersion liquid containing particles of antimony-doped tin oxide at a solid content concentration of 20% by weight. The pH of the particle dispersion liquid was 3.3. The average particle diameter of the particles was 9 nm.

Subsequently, 100 g of the aforementioned particle dispersion liquid was adjusted to 25° C., 4.0 g of tetraethoxysilane (ethyl orthosilicate available from Tama Chemicals Co., Ltd., SiO₂ concentration: 28.8%) was added over 3 minutes, and the mixture was then stirred for 30 minutes. After that, 100 g of ethanol was added to the mixture over 1 minute, the temperature was increased to 50° C. over 30 minutes, and a heating treatment was performed for 15 hours. The solid content concentration of the dispersion liquid after the heating treatment was 10%.

Subsequently, water and ethanol as a dispersion medium were replaced by ethanol through an ultrafiltration membrane. As a result, a dispersion liquid containing the particles of antimony-doped tin oxide coated with silica as metal oxide particles (P1) at a solid content concentration of 20% was obtained. A plurality of the metal oxide particles (P1) were aggregated and chain-linked. At that time, the average number of linkages of the metal oxide particles (P1) was 5.

### Example 1

### (1-1. Production of Antistatic Agent)

A composition (R1) of ultraviolet light curing polymerizable monomers containing dipentaerythritol hexaacrylate (hereinafter sometimes abbreviated as “DP6A”), dipentaerythritol pentaacrylate (hereinafter sometimes abbreviated as “DP5A”), and dipentaerythritol tetraacrylate (hereinafter sometimes abbreviated as “DP4A”) was prepared. In the composition (R1) of the polymerizable monomer, the ratio by weight of each component DP6A/DP5A/DP4A was 64/17/19. The solid content concentration of the composition (R1) of the polymerizable monomer was 100%.

As a multifunctional urethane acrylate (U1), a urethane acrylate obtained by a reaction between 222 parts by weight of isophorone diisocyanate with 795 parts by weight of a mixture of pentaerythritol triacrylate (hereinafter sometimes abbreviated as “PE3A”) and pentaerythritol tetraacrylate (hereinafter sometimes abbreviated as “PE4A”) (PE3A/PE4A=75/25 (by weight)) was prepared. The solid content concentration of the multifunctional urethane acrylate (U1) was 100%.

A mixture of ethanol, normal propyl alcohol, methanol, and water was prepared as a mixed ethanol. In the mixed ethanol, the ratio by weight of each component ethanol/normal propyl alcohol/methanol/water was 85.5/9.6/4.9/0.2.

29.4 Parts by weight of the composition (R1) of the polymerizable monomer, 12.6 parts by weight of the multifunctional urethane acrylate (U1), 7.3 parts by weight of methyl ethyl ketone, 7.3 parts by weight of the mixed ethanol, 7.3 parts by weight of acetylacetone, and 0.86 parts by weight of a photopolymerization initiator (“IRGACURE 184” available from BASF Japan Ltd., solid content: 100%) were sufficiently mixed, to obtain a mixed liquid. To the mixed liquid, 35.0 parts by weight of the dispersion liquid of the metal oxide particles (P1) (solid content: 20%) produced in Production Example 1 and 0.24 parts by weight of an acrylic surfactant (solid content: 100%) were added, and the mixture was uniformly mixed, to obtain a liquid composition having active energy beam curing properties as an antistatic agent (A1).

### (1-2. Production of Substrate Film Layer and Bonding of Masking Film)

100 Parts of a dried thermoplastic resin containing an alicyclic structure-containing polymer (COP1) (available from ZEON Corporation, glass transition temperature: 123° C.) and 5.5 parts of a benzotriazole-based ultraviolet absorber (“LA-31” available from ADEKA Corporation) were mixed by a biaxial extruder. Subsequently, the mixture was fed to a hopper connected to an extruder, supplied to the uniaxial extruder, and melt-extruded, to obtain a thermoplastic resin (J1) containing the ultraviolet absorber. The amount of the ultraviolet absorber in the thermoplastic resin (J1) was 5.2% by weight.

A uniaxial extruder that was provided with a leaf disc-shaped polymer filter having an opening of 3 Lm and had a double-flight type screw diameter of 50 mm (ratio L/D of screw effective length L relative to screw diameter D=32) was prepared. To the hopper provided in the uniaxial extruder, the aforementioned thermoplastic resin (J1) was fed. The thermoplastic resin (J1) was melted, and the melted thermoplastic resin (J1) was supplied to a multi-manifold die at an outlet temperature of the extruder of 280° C. and a revolution speed of a gear pump of the extruder of 10 rpm. The arithmetic surface roughness Ra of a die lip of the multi-manifold die was 0.1 Lm.

In addition to the uniaxial extruder to which the thermoplastic resin (J1) was fed, another uniaxial extruder that was provided with a leaf disc-shaped polymer filter having an opening 3 μm and had a screw diameter of 50 mm (L/D=32) was prepared. To the hopper provided in the uniaxial extruder, a thermoplastic resin (COP1) containing an alicyclic structure-containing polymer that was the same as that used in production of the thermoplastic resin (J1) was fed. The thermoplastic resin (COP1) was melted, and the melted thermoplastic resin (COP1) was supplied to the aforementioned multi-manifold die at an outlet temperature of the extruder of 285° C. and a revolution speed of a gear pump of the extruder of 4 rpm.

The melted thermoplastic resin (COP1), the melted thermoplastic resin (J1) containing the ultraviolet absorber, and the melted thermoplastic resin (COP1) were each discharged from the multi-manifold die at 280° C., and casted on a cooling roller of which the temperature was adjusted to 150° C., to obtain a pre-stretch film. During discharging of the resins, the amount of air gap was set to 50 mm. As a method for casting the discharged resins on the cooling roller, edge pinning was adopted.

The resulting pre-stretch film was a film of three-layered structure having a resin layer with a thickness of 8.5 Lm formed of the thermoplastic resin (COP1), a resin layer with a thickness of 18 μm formed of the thermoplastic resin (J1) containing the ultraviolet absorber, and a resin layer with a thickness of 8.5 μm formed of the thermoplastic resin (COP1) in this order. The pre-stretch film had a width of 1,400 mm and a total thickness of 35 μm. The pre-stretch film thus obtained was subjected to a trimming treatment in which both ends with 50 mm of the pre-stretch film in a widthwise direction were cut off. Thus, the width of the pre-stretch film was 1,300 mm.

The pre-stretch film was stretched in a diagonal direction that was not parallel or perpendicular to the lengthwise direction of the pre-stretch film at a stretching temperature of 140° C. and a stretching rate of 20 m/min, to obtain a stretched film as a substrate film layer.

Subsequently, the substrate film layer was passed through a cooling zone for cooling. A masking film 1 was bonded to one surface of the substrate film layer, to obtain a multilayer film. The masking film 1 included a supporting film layer (thickness: 38 μm) formed of polyethylene terephthalate and a tacky layer (thickness: 14 μm) formed of an acrylic tacky agent, and was bonded to the substrate film layer through a tacky surface (arithmetic average roughness Ra=0.01 μm, and average distance between concave and convex portions Sm=0.9 mm) of the masking film 1 that was a surface on a side of the tacky layer. The Si amount on a surface on a side opposite to the tacky surface of the masking film 1 was 1.0 atm % or less, and the haze of the masking film 1 was 3.0%.

After that, while end parts of the obtained multilayer film were trimmed, the multilayer film was wound under conditions of a winding tension of 120 N/m and a touch pressure using a rubber touch roller of 0.2 MPa in a manner such that the masking film 1 was on the outside. Thus, a roll-shaped multilayer film with a width of 1,330 mm was obtained. The resulting multilayer film included the substrate film layer including a first surface layer with a thickness of 6.0 μm formed of the thermoplastic resin (COP1), an intermediate layer with a thickness of 13.0 μm formed of the thermoplastic resin (J1) containing the ultraviolet absorber, and a second surface layer with a thickness of 6.0 μm formed of the thermoplastic resin (COP1); and the masking film with a thickness of 52 μm in this order.

A part of the multilayer film was unwound from the roll of the multilayer film. The masking film was peeled, and the in-plane retardation Re, orientation angle, and light transmittance at a wavelength of 380 nm of the substrate film layer were measured by the methods described above.

### (1-3. Production of Antistatic Film)

The multilayer film wound into a roll shape was stored for 24 hours in a state of a roll. After that, the multilayer film was unwound from the roll, and a surface of the substrate film layer on a side opposite to the masking film 1 was subjected to a corona treatment (output: 0.4 kW, electrical discharge amount: 200 W·min/m²). Onto the surface that had been subjected to the corona treatment, the antistatic agent (A1) was applied by a die coater so that the thickness of an antistatic layer to be obtained after curing was 3.0 μm. Thus, a film of the antistatic agent (A1) was formed. The application of the antistatic agent (A1) was performed in an environment of relative humidity of 50%.

Subsequently, the film of the antistatic agent (A1) was dried at 60° C. for 2 minutes, and irradiated with light of 250 mJ/cm² by a high-pressure mercury lamp for curing. Thus, the antistatic layer was obtained. As a result, an antistatic film including the masking film 1, the substrate film layer, and the antistatic layer in this order was obtained. The obtained antistatic film was wound into a roll shape at a winding tension of 200 N. The antistatic layer and antistatic film thus obtained were evaluated by the methods described above.

### (1-4. Production of Polarizing Plate)

A polarizer produced by doping a resin film with iodine and stretching the resin film in one direction was prepared. The antistatic film was unwound from the roll of the antistatic film, and the masking film 1 was peeled, to expose a surface of the substrate film layer on a side opposite to the antistatic layer. The exposed surface of the substrate film layer and one surface of the polarizer were bonded through an ultraviolet light curing acrylic adhesive. At that time, the slow axis of the substrate film layer was disposed at an angle of 45° relative to the transmission axis of the polarizer.

To another surface of the polarizer, a cycloolefin film that had been subjected to transversal uniaxial stretching was bonded as a polarizing plate protective film through an ultraviolet light curing acrylic adhesive. At that time, the slow axis of the cycloolefin film was disposed so as to be parallel to the transmission axis of the polarizer.

Subsequently, the adhesive was irradiated with ultraviolet light for curing. Thus, a polarizing plate including the polarizing plate protective film, a layer of the adhesive, the polarizer, a layer of the adhesive, the substrate film layer, and the antistatic layer in this order in a thickness direction was obtained.

### (1-5. Production of Liquid Crystal Display Device)

The polarizing plate was incorporated into a liquid crystal panel including an in-cell type liquid crystal cell provided with a touch sensor, to produce a liquid crystal display device. In the production, the direction of the polarizing plate was set so that a surface on a side of the antistatic layer faced a visual recognition side.

The image visibility of the produced liquid crystal display device was evaluated by the aforementioned method. When the display surface of the liquid crystal display device was observed through polarized sunglasses, the color tone was not changed, the image was not blurred, and the image was visually recognized. From the result of evaluation, the image visibility was determined as “3”.

The stability of liquid crystal driving of the produced liquid crystal display device was evaluated by the aforementioned method. When the touch panel of the liquid crystal display device was operated, the image was visually recognized without occurrence of disordered liquid crystal driving. From the result of evaluation, the stability was determined as “3”.

### Example 2

In the step (1-3) described above, the thickness of the antistatic layer was changed to 1.2 μm by adjusting the application thickness of the antistatic agent (A1). In the same manner as in Example 1 except for the aforementioned matter, an antistatic film was produced and evaluated, and a liquid crystal display device was produced and evaluated. In evaluation of stability of liquid crystal driving of the liquid crystal display device of Example 2, unevenness in liquid crystal driving due to electrical charging was slightly observed, but there was substantially no problem for practical use.

### Example 3

In the step (1-3) described above, the thickness of the antistatic layer was changed to 11.0 in by adjusting the application thickness of the antistatic agent (A1). In the same manner as in Example 1 except for the aforementioned matter, an antistatic film was produced and evaluated, and a liquid crystal display device was produced and evaluated. In Example 3, an image on the liquid crystal display device was slightly blurred with an increase in haze value, and the visibility of the liquid crystal display device was slightly deteriorated, as compared with Example 1. However, there was substantially no problem for practical use.

### Example 4

In the step (1-1) described above, the amount of the dispersion liquid of the metal oxide particles (P1) produced in Production Example 1 was changed to 5.0 parts by weight. In the same manner as in Example 1 except for the aforementioned matter, an antistatic film was produced and evaluated, and a liquid crystal display device was produced and evaluated. In Example 4, as compared with Example 1, reduction in the density of the metal oxide particles (P1) caused decrease in the refractive index of the antistatic layer. Consequently, the difference in refractive index between the substrate film layer and the antistatic layer increased, and interference unevenness was caused, to slightly cause color unevenness on the image on the liquid crystal display device. This led to slight deterioration of the visibility of the liquid crystal display device. Further, the surface resistance increased, and thereby unevenness in liquid crystal driving was slightly observed. However, in the image visibility and the stability of liquid crystal driving, there was substantially no problem for practical use.

### Example 5

In the step (1-1) described above, the amount of the dispersion liquid of the metal oxide particles (P1) produced in Production Example 1 was changed to 100.0 parts by weight. In the same manner as in Example 1 except for the aforementioned matter, an antistatic film was produced and evaluated, and a liquid crystal display device was produced and evaluated. In Example 5, as compared with Example 1, increase in the density of the metal oxide particles (P1) caused increase in the refractive index of the antistatic layer. Consequently, the difference in refractive index between the substrate film layer and the antistatic layer increased, and interference unevenness was caused to slightly cause color unevenness on the image on the liquid crystal display device. This led to slight deterioration of the visibility of the liquid crystal display device. However, there was substantially no problem for practical use.

### Example 6

In the step (1-2) described above, the masking film 1 was changed to a masking film 2. The masking film 2 included a supporting film layer (thickness: 40 μm) formed of polyethylene and a tacky layer (thickness: 10 μm) formed of an acrylic tacky agent, and was bonded to the substrate film layer through a tacky surface (arithmetic average roughness Ra=0.05 μm, and average distance between concave and convex portions Sm=0.71 mm) of the masking film 2 that was a surface on a side of the tacky layer. The Si amount on a surface on a side opposite to the tacky surface of the masking film 2 was 1.0 atm % or less, and the haze of the masking film 2 was 3.5%. In the same manner as in Example 1 except for the aforementioned matter, an antistatic film was produced and evaluated, and a liquid crystal display device was produced and evaluated. In Example 6, as compared with Example 1, increase in the surface roughness of the masking film caused decrease in the image clarity (DOI) of the antistatic layer. Consequently, display unevenness occurred on an image on the liquid crystal display device, and the visibility of the liquid crystal display device was slightly deteriorated. However, there was substantially no problem for practical use.

### Example 7

In the step (1-2) described above, the stretching temperature for the pre-stretch film was changed to 143° C. In the same manner as in Example 1 except for the aforementioned matter, an antistatic film was produced and evaluated, and a liquid crystal display device was produced and evaluated. In Example 7, as compared with Example 1, the in-plane retardation of the substrate film layer decreased. Consequently, change in color tone was slightly observed when the set position of the liquid crystal display device was changed, and the visibility of the liquid crystal display device was slightly deteriorated. However, there was substantially no problem for practical use.

### Example 8

In the step (1-2) described above, the thickness of the pre-stretch film was changed to 70 Lm by adjusting the revolution speed of gear pump during production of the pre-stretch film, and the stretching temperature of the pre-stretch film was changed to 147° C. In the same manner as in Example 1 except for the aforementioned matter, an antistatic film was produced and evaluated, and a liquid crystal display device was produced and evaluated. In Example 8, as compared with Example 1, the in-plane retardation of the substrate film layer increased. Consequently, change in color tone was slightly observed when the set position of the liquid crystal display device was changed, and the visibility of the liquid crystal display device was slightly deteriorated. However, there was substantially no problem for practical use.

### Comparative Example 1

In the step (1-1) described above, the dispersion liquid of the metal oxide particles (P1) produced in Production Example 1 was not used. In the same manner as in Example 1 except for the aforementioned matter, an antistatic film was produced and evaluated, and a liquid crystal display device was produced and evaluated. In Comparative Example 1, there occurred a large unevenness of liquid crystal driving of the liquid crystal display device, and practical problems such as operation failure happened.

### Comparative Example 2

In the step (1-2) described above, the masking film 1 was changed to a masking film 3. The masking film 3 included a supporting film layer (thickness: 30 μm) formed of polyethylene and a weak tacky layer (thickness: 10 μm), and was bonded to the substrate film layer through a tacky surface (arithmetic average roughness Ra=0.09 μm, and average distance between concave and convex portions Sm=0.53 mm) of the masking film 3 that was a surface on a side of the weak tacky layer. The Si amount on a surface on a side opposite to the tacky surface of the masking film 3 was 1.0 atm % or less, and the haze of the masking film 3 was 5.5%. In the same manner as in Example 1 except for the aforementioned matter, an antistatic film was produced and evaluated, and a liquid crystal display device was produced and evaluated. In Comparative Example 2, as compared with Example 1, increase in the surface roughness of the masking film caused significant decrease in the image clarity (DOI). Consequently, there occurred a large display unevenness on an image on the liquid crystal display device, and practical problems such as operation failure happened.

[Results]

The results in Examples and Comparative Examples described above are shown in the following Tables 1 and 2. Meanings of abbreviations in the following Tables are as follows.

Re: in-plane retardation

Ra: arithmetic average roughness

Sm: average distance between concave and convex portions

Difference in refractive index: difference in refractive index between substrate film layer and antistatic layer

DOI: image clarity of surface of antistatic layer

TABLE 1
Results of Examples

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Substrate film layer | | | | | | | | 5 |
| Thickness (μm) | 25 | 25 | 25 | 25 | 25 | 25 | 25 | 47 |
| 380 nm light transmittance | 6.0 | 6.0 | 6.0 | 6.0 | 6.0 | 6.0 | 6.0 | 0.05 |
| (%) | | | | | | | | |
| Re (nm) | 130 | 130 | 130 | 130 | 130 | 130 | 60 | 200 |
| Orientation angle | 45.5 | 45.5 | 45.5 | 45.5 | 45.5 | 45.5 | 45.5 | 45.5 |
| (°) | | | | | | | | |
| Refractive index | 1.53 | 1.53 | 1.53 | 1.53 | 1.53 | 1.53 | 1.53 | 1.53 |
| Masking film | | | | | | | | |
| Ra (μm) | 0.01 | 0.01 | 0.01 | 0.01 | 0.01 | 0.05 | 0.01 | 0.01 |
| Sm (mm) | 0.90 | 0.90 | 0.90 | 0.90 | 0.90 | 0.71 | 0.90 | 0.90 |
| Antistatic layer | | | | | | | | |
| Metal oxide particles | SnO—Sb | SnO—Sb | SnO—Sb | SnO—Sb | SnO—Sb | SnO—Sb | SnO—Sb | SnO—Sb |
| Surface resistance | 2.0 × 10⁸ | 1.0 × 10⁹ | 1.0 × 10⁷ | 7.0 × 10⁹ | 1.0 × 10⁸ | 2.5 × 10⁸ | 2.0 × 10⁸ | 2.0 × 10⁸ |
| (Ω/sq.) | | | | | | | | |
| Film thickness (μm) | 3.0 | 1.2 | 11.0 | 3.0 | 3.0 | 3.0 | 3.0 | 3.0 |
| Refractive index | 1.54 | 1.54 | 1.54 | 1.49 | 1.565 | 1.54 | 1.54 | 1.54 |
| Refractive index difference | 0.01 | 0.01 | 0.01 | 0.04 | 0.035 | 0.01 | 0.01 | 0.01 |
| Antistatic film | | | | | | | | |
| DOI | 95.8 | 96 | 94.5 | 93 | 93.5 | 91.0 | 95.5 | 95.5 |
| Haze (%) | 0.02 | 0.01 | 0.29 | 0.02 | 0.25 | 0.02 | 0.02 | 0.02 |
| Image visibility evaluation | 3 | 3 | 2 | 2 | 2 | 2 | 2 | 2 |
| Liquid crystal driving | 3 | 2 | 3 | 2 | 3 | 3 | 3 | 3 |
| stability evaluation | | | | | | | | |

TABLE 2
Results of Comparative Examples

| | Comp. Ex. 1 | Comp. Ex. 2 |
|---|---|---|
| Substrate film layer | | |
| Thickness (μm) | 25 | 25 |
| 380 nm light transmittance (%) | 6.0 | 6.0 |
| Re (nm) | 130 | 130 |
| Orientation angle (°) | 45.5 | 45.5 |
| Refractive index | 1.53 | 1.53 |
| Masking film | | |
| Ra (μm) | 0.01 | 0.09 |
| Sm (mm) | 0.90 | 0.53 |
| Antistatic layer | | |
| Metal oxide particles | Not added | SnO—Sb |
| Surface resistance | 1.0 × 10¹⁴ | 2.0 × 10⁸ |
| (Ω/sq.) | | |
| Film thickness (μm) | 3.0 | 3.0 |
| Refractive index | 1.48 | 1.54 |
| Refractive index difference | 0.05 | 0.01 |
| Antistatic film | | |
| DOI | 92 | 86 |
| Haze (%) | 0.02 | 0.02 |
| Image visibility evaluation | 2 | 1 |
| Liquid crystal driving stability | 1 | 3 |
| evaluation | | |

[Discussion]

It is apparent that the antistatic films produced in Examples all have low surface resistance values of the antistatic layer, and thus has high antistatic properties. In all the antistatic films produced in Examples, the image clarity is high and the outer appearance is favorable. In the liquid crystal display devices provided with the antistatic films produced in Examples, both the image visibility and the stability of liquid crystal driving are excellent. Therefore, according to the present invention, both the image visibility and the stability of liquid crystal driving of the liquid crystal display device can be improved. Accordingly, it is confirmed that the image quality of the liquid crystal display device can be effectively improved.

### REFERENCE SIGN LIST

100 antistatic film
110 substrate film layer
120 antistatic layer
130 masking film
200 polarizing plate
210 polarizer
220 polarizing plate protective film
300 liquid crystal display device
310 liquid crystal cell
320 polarizing plate
330 polarizing plate protective film
340 polarizer
350 polarizing plate protective film
360 drawing electrode

1. An antistatic film comprising: a substrate film layer formed of a thermoplastic resin containing a polymer containing an alicyclic structure; and an antistatic layer containing metal oxide particles having electroconductivity, the antistatic layer being provided on the substrate film layer, wherein
the antistatic layer has a surface resistance of 1.0×10⁶ Ω/square or more and 1.0×10¹⁰ Ω/square or less, and
image clarity of a surface of the antistatic layer is 90 or more.

2. The antistatic film according to claim 1, comprising a masking film on a surface of the substrate film layer on a side opposite to the antistatic layer.

3. The antistatic film according to claim 2, wherein
the masking film is in contact with a surface of the substrate film layer on a side of the substrate film layer, and
an arithmetic average roughness Ra and an average distance between concave and convex portions Sm of the surface of the masking film being in contact with the substrate film layer satisfy the following Expressions (i) and (ii):
Ra<0.08 μm Expression (i), and
Sm>0.6 mm Expression (ii).

4. The antistatic film according to claim 1, wherein
the substrate film layer includes a first surface layer, an intermediate layer, and a second surface layer in this order,
the intermediate layer contains an ultraviolet absorber,
the substrate film layer has a thickness of 10 μm or more and 60 μm or less, and
a light transmittance of the substrate film layer at a wavelength of 380 nm is 10% or less.

5. The antistatic film according to claim 1, wherein the antistatic layer has a single-layer structure, and
a thickness of the antistatic layer is 0.8 μm to 10.0 μm.

6. The antistatic film according to claim 1, wherein a difference in refractive index between the antistatic layer and the substrate film layer is 0.03 or less.

7. The antistatic film according to claim 1, wherein the antistatic film has a haze value of 0.3% or less.

8. The antistatic film according to claim 1, wherein the antistatic film is a long-length film wound into a roll shape.

9. The antistatic film according to claim 8, wherein
an in-plane retardation at a wavelength of 550 nm of the substrate film layer is 80 nm to 180 nm, and
an angle of a slow axis of the substrate film layer relative to a lengthwise direction of the substrate film layer is 45°±5°.

10. A polarizing plate comprising the antistatic film according to claim 1.

11. A liquid crystal display device comprising a liquid crystal cell and the polarizing plate according to claim 10.

12. The liquid crystal display device according to claim 11, wherein the liquid crystal cell is electrically connected to the antistatic layer of the antistatic film.

13. The liquid crystal display device according to claim 11, wherein the liquid crystal display device is an IPS mode liquid crystal display device.

14. A method for producing an antistatic film comprising the steps of:
bonding a masking film to a substrate film layer formed of a thermoplastic resin containing a polymer containing an alicyclic structure to obtain a multilayer film;
winding the multilayer film into a roll shape;
unwinding the roll-shaped wound multilayer film; and
forming an antistatic layer on the substrate film layer of the unwound multilayer film on a side opposite to the masking film, the antistatic layer containing metal oxide particles having electroconductivity, wherein
the antistatic layer has a surface resistance of 1.0×10⁶ Ω/square or more and 1.0×10¹⁰ Ω/square or less, and
image clarity of surface of the antistatic layer is 90 or more.

15. The method for producing an antistatic film according to claim 14, wherein an arithmetic average roughness Ra and an average distance between concave and convex portions Sm of a surface of the masking film in contact with the substrate film layer satisfy the following Expressions (i) and (ii):
Ra<0.08 μm Expression (i), and
Sm>0.6 mm Expression (ii).

16. The method for producing an antistatic film according to claim 14, wherein in the step of winding the multilayer film into a roll shape, a rubber roll is brought into contact with a surface of the multilayer film at a touch pressure of 0.05 MPa or more and 1.5 MPa or less and winding of the multilayer film is performed at a winding tension of 50 N/m or more and 250 N/m or less and such that the masking film is on the outside.
